(19) United States
(12) Patent Application Publication
(10) Pub. No.: US 2017/0051598 A1
(43) Pub. Date: Feb. 23, 2017

(54) System For Hydraulic Fracturing Design And Optimization In Naturally Fractured Reservoirs

(71) Applicant: FracGeo, LLC, The Woodlands, TX (US)

(72) Inventor: Ahmed Ouenes, Centennial, CO (US)

(73) Assignee: FracGeo, LLC, The Woodlands, TX (US)

(21) Appl. No.: 15/045,861

(22) Filed: Feb. 17, 2016

Related U.S. Application Data
(60) Provisional application No. 62/207,569, filed on Aug. 20, 2015.

(51) Int. Cl. E21B 43/26; G06F 17/50; E21B 41/00

(52) U.S. Cl. CPC E21B 43/26; E21B 41/0092; G06F 17/5009; E21B 7/046

(57) ABSTRACT

A method for optimizing hydraulic fracturing and refracturing simulates the geomechanical interaction between regional stress and natural fractures in a reservoir. An equivalent fracture model is created from data on the natural fracture density, regional stress and elastic properties of the reservoir, so that points in the reservoir are assigned a fracture length and fracture orientation. The horizontal differential stress and maximum principal stress direction at points in the reservoir are then estimated by meshless particle-based geomechanical simulation using the equivalent fracture model as an input. Regions in the reservoir having low differential stress based on the simulation can then be selected for initial hydraulic fracturing. Regions in the reservoir having high differential stress based on the simulation can then be selected for refracturing.

### RELATED APPLICATION

The present application is based on and claims priority to the Applicant's U.S. Provisional Patent Application 62/207,569, entitled “System For Hydraulic Fracturing Design And Optimization In Naturally Fractured Reservoirs,” filed on Aug. 20, 2015.

### BACKGROUND OF THE INVENTION

Field of the Invention

The present invention relates generally to the field of systems for hydraulic fracturing or refracturing of wells. More specifically, the present invention discloses a system for optimizing hydraulic fracturing or refracturing and the position of wellbores to increase production, and to reduce drilling and completion costs and the impact of drilling and hydraulic fracturing on the environment by saving water and sand used as proppant. The present invention can also be used in interpreting microseismic surveys and to provide some inputs to common hydraulic fracturing design and reservoir simulation software.

Background of the Invention

The statements in this section merely provide background information related to the present disclosure and may not constitute prior art.

Large hydrocarbons resources are locked around the world in unconventional reservoirs such as tight sands, tight carbonates, and shale reservoirs all characterized by an intrinsic very low permeability that does not allow the natural flow of oil or gas to the drilled wellbores. Producing these unconventional hydrocarbons is achieved by primarily hydraulic fracturing which will create artificially the necessary permeability by pumping into the wellbore certain fluids to break the rock and create a complex network of induced fractures.

In a subterranean reservoir, the weight of the overburden and most often tectonic activities gives rise to vertical and horizontal stresses that create natural fractures. In its turn, the resulting natural fracture system interacts with the regional stress and create a heterogeneous stress field with locally varying maximum horizontal stress directions. When hydraulic fracturing is initiated in a wellbore in this heterogeneous stress field perturbed by the natural fractures, the final permeability that will allow hydrocarbon production depends on the interaction between the induced hydraulic fractures and the pre-existing natural fractures. The potential role played by the natural fractures in the process of hydraulic fracturing and its impact on the hydrocarbon production from the wellbore has been noted by authors in the field. However, the actual modeling of the interactions between hydraulic and natural fractures has been absent in most current hydraulic fracturing design tools.

For many years, hydraulic fracturing was modeled with ideal bi-wing planar fractures that do not interact with any natural fracture. The bi-wing models started with simple 2D models, but have evolved to become pseudo-3D models. Among the multiple deficiencies of current bi-wing hydraulic fracture simulations technologies is their inability to correctly account for fluid leak-off caused by the natural fractures interacting with the hydraulic fractures. To address these shortcomings, various computational methods have been used to model the complex interaction between the induced and natural fractures. These new methods include finite elements, finite difference, boundary elements, block spring model, extended finite element, distinct element method, hybrid finite/discrete elements, and particle methods. Unfortunately, most of these computational methods do not use a realistic description of the natural fractures driven by geophysical and geologic constraints, and do not account for the multitude of interactions which occur between hydraulic and natural fractures.

As a result the current computational methods taken separately are not able to predict either microseismicity, or completion stage performance indicators such as production logs or tracers tests that are validated with real well data. This lack of a mechanistic model that is able to be validated with microseismic and engineering data measuring completion stage performance in real field validations, hampers the ability to solve practical completion optimization problems in wellbores drilled in fractured subterranean reservoirs. Among the deficiencies of the current methods to handle the interaction between hydraulic and natural fractures is their inability to seamlessly input, prior to any simulation of hydraulic fracturing, the proper initial geomechanical conditions that are the result of the interaction between the regional stress and the natural fractures, the heterogeneous rock elastic properties and the pressure depletion of existing wells. These initial conditions are sometimes simulated in other geomechanical software which most frequently do not account for the detailed natural fracture model and its impact on the initial stress field and maximum horizontal stress direction that play a major role as the proper initial conditions prior to any realistic simulation of the hydraulic fracturing where the interaction between hydraulic and natural fractures are accounted for. As a result of these technical challenges, conventional modeling technologies and software have been unable to provide the necessary information needed by drilling and completion engineers in a very short time frame of few hours to selectively place their wellbores and completion stages in a way that leads to the highest hydrocarbon production while reducing the costs and the environmental impact to the strict minimum. Based on extensive data from many unconventional wells drilled in North America, it has been estimated that 40% of the unconventional wells are uneconomical due to the poor positioning of the drilled wellbores and poor selection of the completion stages. One possible cause of the poor placement of the wellbores and completion stages is the unavailability of technologies that allow the rapid identification and mapping of geomechanical sweet spots where the wells should be drilled and completion stages selected. Providing a means for estimating the differential stress in a subterranean formation would assist in defining and mapping these geomechanical sweet spots.

Until recently, two approaches have been used conventionally by shale operators to estimate differential stress for the purpose of drilling and completion. The most common approach relies on well logging using various types of dipole sonic logs. Although logging tools can be very useful, they are of limited use once the well is drilled since the driller cannot change its position if it encounters many areas of high differential stress that will not provide successful completion stages. Another approach is needed to estimate the differential stress across the entire study area before any well is drilled and logged. To accomplish this goal, the present invention uses other methods that could provide the differential stress prediction over a larger scale.

Prior-art approaches have used wide-angle, wide azimuth 3D seismic data and some drastic assumptions to estimate the principal stresses as well as rock strength properties. The derived dynamic stresses provides a good indication of the variability of the differential stress over a large area covered by the 3D seismic. In this approach, the identification of the high and low values of differential stress is the ultimate objective and if needed these dynamic estimates of stress and rock mechanical properties could be calibrated to well logs and core data for their subsequent use in geomechanical modeling. Unfortunately, this approach is limited in use since most of the available 3D seismic are not wide angle and azimuth, and the processing of such seismic data to retrieve the differential stress is a very complex and time-consuming process that could take many months. An alternative method to quickly compute the differential stress in few hours instead of months is provided in the present disclosure.

Accordingly, there remains a need for developing a robust workflow that combines in a mechanistic model the simultaneous use of geology, geophysics and geomechanics, devices, and systems for the estimation of the horizontal differential stress and the local maximum horizontal stress directions for completion optimization in fractured subterranean reservoirs to increase hydrocarbon production, reduce drilling and completion costs and reduce the impact on the environment by saving water and sand used as proppant.

### SUMMARY OF THE INVENTION

This invention provides a system for optimizing hydraulic fracturing in naturally-fractured reservoirs by optimizing the position of wellbores and hydraulic fracturing stages to increase production, reduce drilling and completion costs and impact on the environment. Geologic, geophysical and engineering data is initially gathered and processed to estimate the distribution of the natural fractures and the reservoir elastic properties. Stress data is gathered and processed utilizing the derived distribution of natural fractures and elastic properties in a meshless particle-based geomechanical simulator to simulate the geomechanical interaction between the regional stress and the natural fractures to estimate horizontal differential stress and maximum horizontal stress directions. The meshless particle-based geomechanical simulator can use as input an explicit 2D or 3D description of the natural fractures. The geomechanical results include the computation of the normalized horizontal differential stress maps and local maximum horizontal stresses directions to optimize wellbore and completion stage positions that achieve the highest production in the stimulated reservoir volume and that allow a better interpretation of microseismic surveys. Further in some embodiments the horizontal differential stress and maximum horizontal directions from the meshless particle-based geomechanical simulator are used to validate an interpreted acquired microseismic survey and then used in any other wellbore to predict the microseismicity expected if the well is hydraulically fractured. The horizontal differential stress and maximum horizontal stress direction derived from the meshless geomechanical simulator can also be related to stimulated rock permeability in the vicinity of the hydraulically fractured wellbore and can be used as an input in a reservoir simulator to match the production and pressure history of a hydraulically fractured well. Additionally, the horizontal differential stress can be used to derive the asymmetric and variable half-fracture lengths and orientations that can be used as input in conventional hydraulic fracturing design software to overcome their inability to include natural fractures in their mathematical formulation of the propagation of a hydraulic fracture.

A major feature of the present invention is its ability to first combine the continuous representation of the natural fractures as a 2D map or a 3D volume derived from multiple sources that is then transformed into an equivalent fracture model where natural fractures are represented by segments of certain lengths and orientations, which are used as input into a meshless particle-based geomechanical simulator able to represent explicitly the natural fractures. Another major feature is the ability to model in the meshless particle-based method the interaction between the regional stress with the equivalent fracture model to quickly yield (i.e., in only few hours) normalized horizontal differential stress maps and local maximum horizontal stresses directions, which can be used to select optimal wellbore trajectories and completion stages that will increase production from unconventional wells, reduce drilling and completion costs and reduce the impact of drilling and hydraulic fracturing on the environment by saving water and sand used as proppant.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagrammatic representation of a cross section in a pad drilling where four horizontal wellbores are drilled in different directions and in different fractured subterranean reservoirs from one single pad.

FIG. 2 is a diagrammatic representation of an aerial view of a pad drilling where multiple pads each with multiple horizontal wellbores are drilled in different directions.

FIG. 3 is a diagrammatic representation of multiple completion stages interaction with natural fractures in a fractured subterranean reservoirs along a horizontal wellbore.

FIG. 4 is a diagrammatic representation of a multiple asymmetric half-length hydraulic fractures.

FIG. 5 is a diagrammatic flowchart of a method for hydraulic fracturing design and optimization based on the use of the horizontal differential stress and the local maximum horizontal stress directions, in accordance with the present invention.

FIG. 6 is a diagram illustrating aspects of the estimation of a natural fracture model step of the method illustrated in the flow chart of FIG. 5.

FIG. 7 is a diagram showing a template of nine values used to compute the length and orientation of natural fractures from a 2D scalar map.

FIG. 8 is a diagram showing an explicit representation of a natural or hydraulic fracture in the material point method.

FIG. 9 is a diagram showing a 2D map of a seismic proxy for a natural fracture distribution in a pad of two wells that have five hydraulically fractured stages, including their corresponding production logs.

FIG. 10 is a diagram showing an Equivalent Fracture Model (EFM) with the regional stress applied on it.

FIG. 11 is a diagram showing the description of the natural fractures in a meshless particle-based method and the application of the regional stress as a boundary condition.

FIG. 12 is a diagram showing the particle representation of the natural fractures in the meshless particle-based method.

FIG. 13 is a diagram showing the horizontal differential stress map.

FIG. 14 is a diagram showing a region of the differential stress around a well with its interpreted microseismicity and production logs at each hydraulically-fractured stage.

FIG. 15 is a diagram showing the normalized differential horizontal stress (NDHS) and the correlation between NDHS values around a hydraulically fractured stage and the production log at that stage.

FIG. 16 is a diagram showing a 2D map of the maximum principal stress directions (MPSD) and the resulting directions plotted as lines.

FIG. 17 is a statistical distribution of the maximum principal stress directions (MPSD) in a localized area shown in FIG. 16 and plotted as a rose diagram showing the multiple directions as compared to the regional stress direction and its validation with microseismic data showing in a localized area an orientation perpendicular to the direction of the regional stress

FIG. 18 is a diagram showing the stress rotation estimated around a hydraulically-fractured stage and its validation with microseismic data showing in a localized area an orientation at an angle from the direction of the regional stress.

FIGS. 19 and 20 are a diagrammatic flow chart of a method for hydraulic fracturing design and optimization based on the use of the horizontal differential stress and the local maximum principal stress directions.

### DETAILED DESCRIPTION OF THE INVENTION

For the purposes of promoting an understanding of the principles of the present invention, reference will now be made to the embodiments illustrated in the drawings, and specific language will be used to describe the same. It is nevertheless understood that no limitation to the scope of the disclosure is intended. Any alterations and further modifications to the described methods, devices, and systems, and any further application of the principles of the present disclosure are fully contemplated and included within the present disclosure as would normally occur to one skilled in the art to which the disclosure relates. In particular, it is fully contemplated that the steps, features or components described with respect to one embodiment may be combined with the steps, features or components described with respect to other embodiments of the present disclosure. For the sake of brevity, however, the numerous iterations of these combinations will not be described separately.

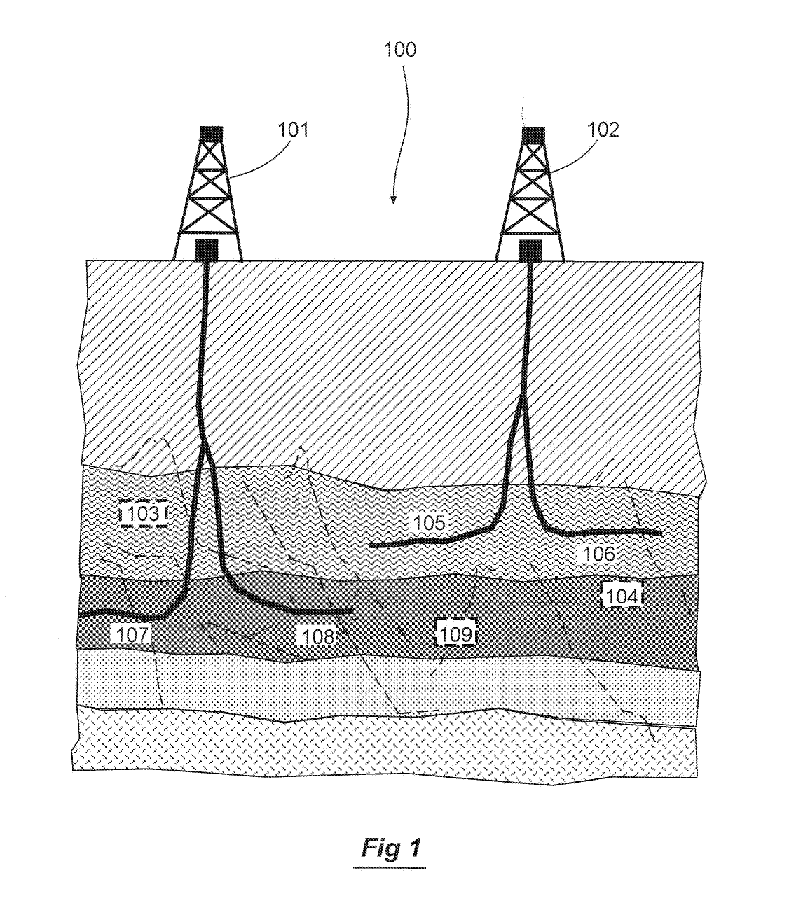

Referring initially to FIG. 1, a cross-section 100 is shown extending across two well surface locations 101 and 102. The surface location 101 has two horizontal wellbores 107 and 108 drilled in the fractured subterranean reservoir 104 and another surface location 102 has two other horizontal wells 105 and 106 drilled in another fractured subterranean reservoir 103. The regions 104 and 103 may include a natural fracture network 109 that extends through one or more subterranean geologic formations.

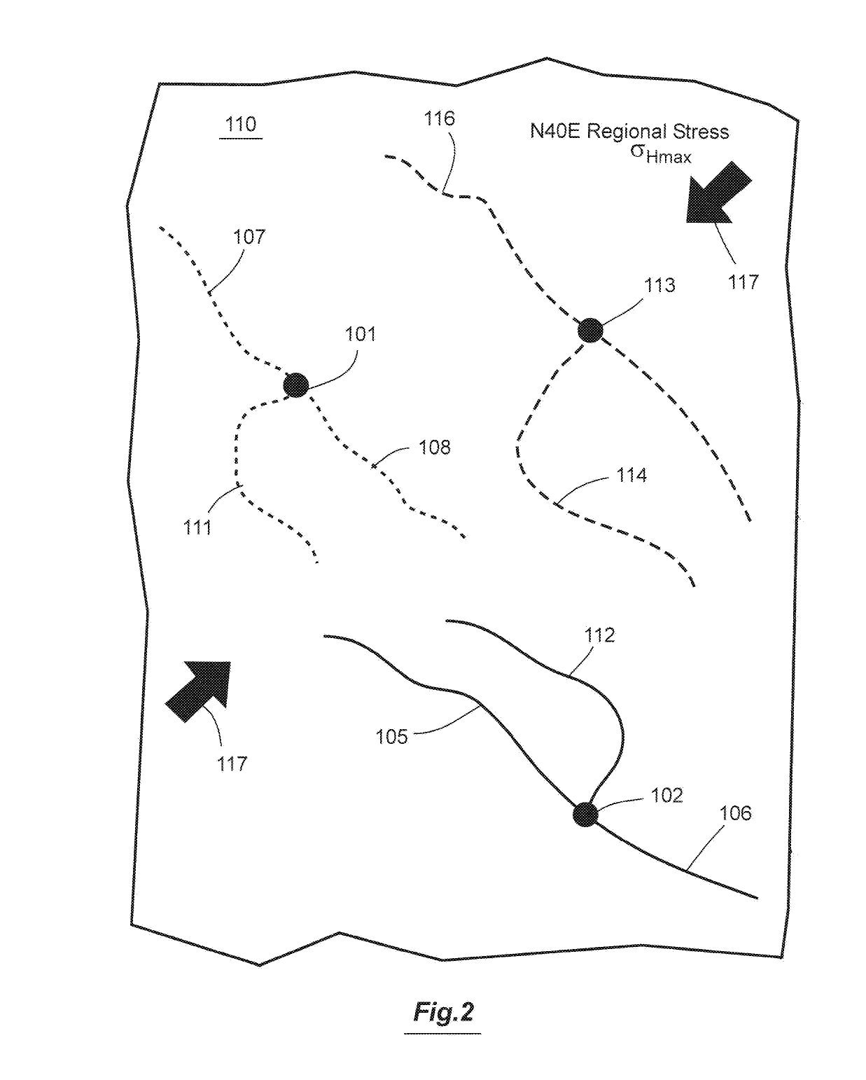

Generally, the cross-section 100 is representative of any type of field 110 shown in FIG. 2 where natural resources are obtained. In some particular instances, the field 110 is an oil field, natural gas field, geothermal field or other natural resources field where multiple surfaces locations 101, 102 and 113 are used to drill vertical wells or multiple horizontal wellbores 105, 106, 107, 108, 111, 112, 114, 115, and 116. The horizontal wellbores are frequently drilled in the direction perpendicular to the regional maximum horizontal stress direction 117 (as shown in FIG. 2) to allow for the development of transverse hydraulic fractures that will grow from the wellbore and in the direction of the maximum horizontal stress 117. In this regard, FIG. 2 shows the location of completed and stimulated horizontal wells 105 (each showing a continuous line for the completed and stimulated wellbore), and the location of drilled but not completed wells 107 (each showing a dotted line for the drilled but not completed wellbore) and the location of undrilled wells 114 (each showing a semi-dashed line for the undrilled wellbore) in a field 110. As will be discussed below, in some instances data regarding the drilled and not completed wells 107 and drilled and completed wells 105 is utilized in different steps of the workflow to estimate different geomechanical results that could be used to optimize the recompletion and refracturing of drilled and completed wells 105, optimize the completion of drilled wells 107 and optimize the drilling and completion of undrilled wells 114

Surface seismic data can be available or not in the field 110. If available, the surface seismic data can be combined with well data to delimit the boundaries of regions 104 and 103 as well as provide information on the elastic properties, the in-situ stress, and the reservoir fluids that affect the propagation of seismic waves in the regions 104 and 103. The following description will primarily focus on the design and completion optimization of vertical, deviated and horizontal wells by targeting geomechanical sweet spots found in low horizontal differential stress zones where the maximum principal stress directions did not rotate considerably from the regional stress direction 117.

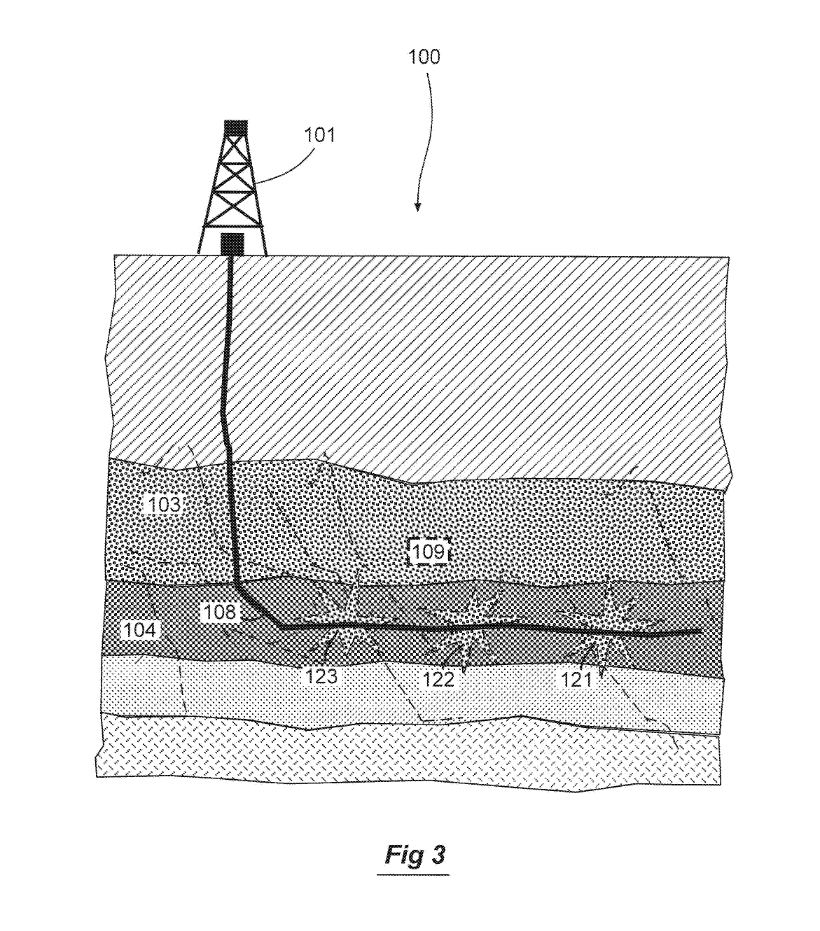

FIG. 3 shows a wellbore 108 that has been drilled, but not completed and stimulated, crossing a fractured subterranean region 104. Multiple logs measuring rock properties are run along wellbore 108 and can be used in the completion optimization process. Wellbore geometry and various sonic logs run along the wellbore 108 provide stress information that could be used in the workflow. In some implementations, the well 101 is used to apply an injection treatment to extract resources from the subterranean formation 104 through the wellbore 108. The example well 101 may be used to create a complex hydraulic fracture 121 in wellbore 108. Properties of the injection treatment can be calculated or selected based on computer simulations of complex hydraulic fracture 121 propagation and interaction with the natural fracture network 109 in the subterranean regions 104 and 103. The spacing between hydraulic fractures 121 and 122, can be optimized to find the best well performance using net present value or any other economic criteria to evaluate the financial impact of the various completion strategies.

During the hydraulic fracturing of wellbore 108, geophones or other types of listening equipment placed inside existing wellbores, at the surface or beneath it can be used to sense microseismic information. During and after the hydraulic fracturing, other measurements which include production logs, tracers, and fiber optics can be collected along wellbore 108 to quantify the efficiency of hydraulic fracture stage 121 and to estimate its contribution to the overall production coming from wellbore 108.

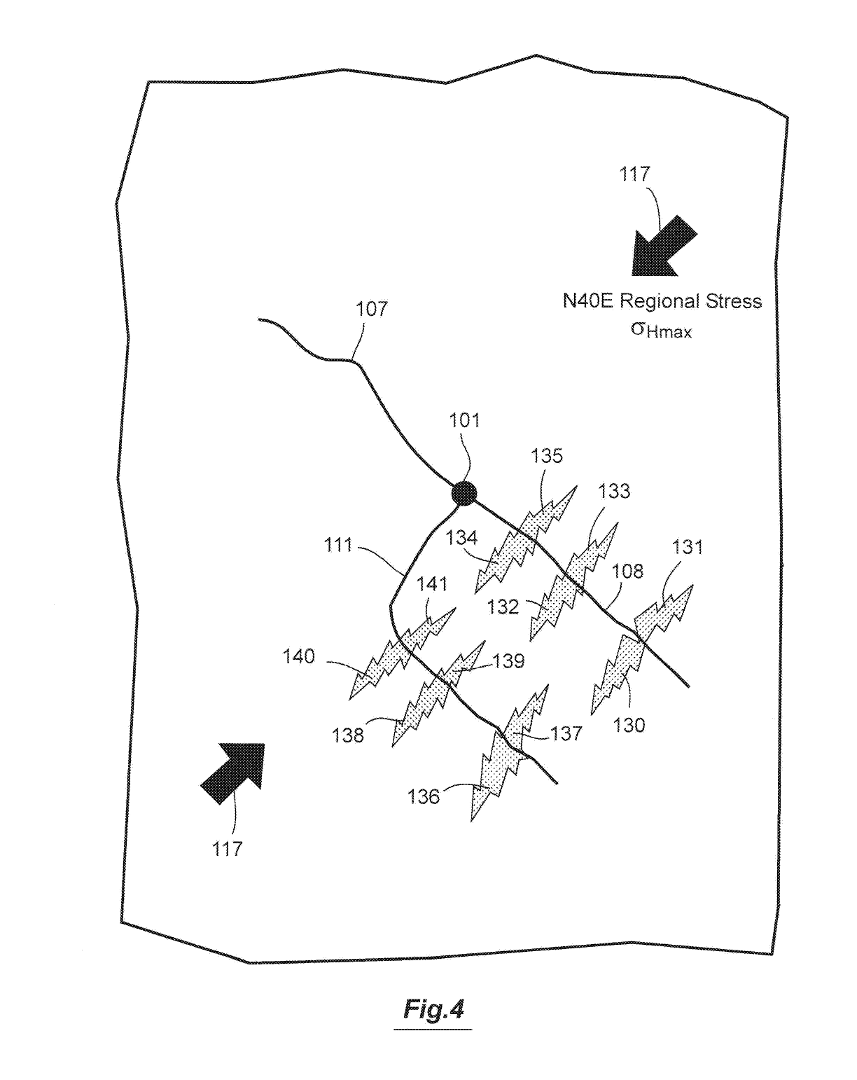

FIG. 4 shows the stimulation of wellbores 108 and 111 with three hydraulic fracturing stages. As will be discussed below, in some instances the workflow will provide the results needed to estimate the optimal number of hydraulic fracturing stages needed for optimal stimulation of wellbores 108 and 111. Properties of the injection treatment can be accomplished in a manner that allows for a controlled hydraulic fracturing sequence to optimize the stimulated volume between wellbores 108 and 111. The sequence of hydraulic fracturing could sequentially treat wellbore 108 by executing frac stage 121 followed by frac stage 122 and finally frac stage 123. The hydraulic fracturing of wellbore 108 will lead to asymmetric and variable half fracture lengths 130 and 131 at hydraulic fracture stage 121, an asymmetric and variable half fracture lengths 132 and 133 at hydraulic fracture stage 122, and an asymmetric and variable half fracture lengths 134 and 135 at hydraulic fracture stage 123. Once the stimulation of wellbore 108 is completed, the sequential hydraulic fracturing of wellbore 111 is initiated by executing a sequence of completion stages. In other implementations, the sequence of hydraulic fracturing could be parallel or simultaneous and treat wellbores 108 and 111 simultaneously by executing completion stages 121 in wellbore 108 and a first completion stage in wellbore 111. The next sequence will execute simultaneously completion stages 122 in wellbore 108 and a second completion stage in wellbore 111. The final sequence will execute simultaneously completion stages 123 in wellbore 108 and a third completion stage in wellbore 111. Alternatively, the sequence of hydraulic fracturing could be a “zipper” and alternate between wellbores 108 to 111.

Depending on the hydraulic fracturing sequence executed on wellbores 108 and 111, the hydraulic fracturing of wellbore 108 will lead to an asymmetric and variable half fracture lengths 130 and 131 at hydraulic fracture stage 121, followed by asymmetric and variable half-fracture lengths 132 and 133 at hydraulic fracture stage 122, and an asymmetric and variable half-fracture lengths 134 and 135 at hydraulic fracture stage 123. For the wellbore 111, the asymmetric and variable half-fracture lengths of the first fracture stage will be 136 and 137, the asymmetric and variable half-fracture lengths of the second fracture stage will be 138 and 139, and the asymmetric and variable half-fracture lengths of the third fracture stage will be 140 and 141.

These asymmetric and variable half-fracture lengths are a simplification of the complex region of stimulated rock volume created by the hydraulic fracturing but they are commonly used in hydraulic fracturing design and reservoir simulation software, which commonly assume these half-fracture lengths to be symmetric, perpendicular to the wellbores and having a constant length across the wellbore. Another assumption commonly made is the orientation of the hydraulic fracture being always in the direction of the maximum horizontal stress direction 117. Unfortunately, the geologic and stress conditions of the subterranean reservoir exhibit large heterogeneities and stress gradients that cause an asymmetric and variable half-fracture length that is not always oriented in the direction of the maximum horizontal stress direction 117 as revealed through microseismic data.

A major geologic factor creating these stress variations and gradients is the presence of the natural fractures system 109 that interacts with the regional stress and its maximum horizontal stress direction 117. The objective of the present invention is to provide a reliable and rapid way to evaluate the geomechanical sweet spots where the hydraulic stimulation will be the most effective and lead to the best and largest stimulated reservoir volume. These geomechanical sweet spots could be identified by estimating the horizontal differential stress and the locally varying maximum principal stress directions in each subterranean fractured formation 103 and 104 across the field 110. The present invention provides a new way to estimate quickly the effects of the interaction between the natural fracture system 109 and the regional stress and its maximum horizontal stress direction 117. Having the differential stress map or 3D volume, an operator will be able to drill wellbores and place completion stages mostly in the zones where low differential stress are predicted, which will help to ensure the successful hydraulic fracturing of a limited number of completion stages thus providing the highest potential hydrocarbon production while keeping the costs of drilling and completion to the strict minimum by saving on water and sand used during the hydraulic fracturing process.

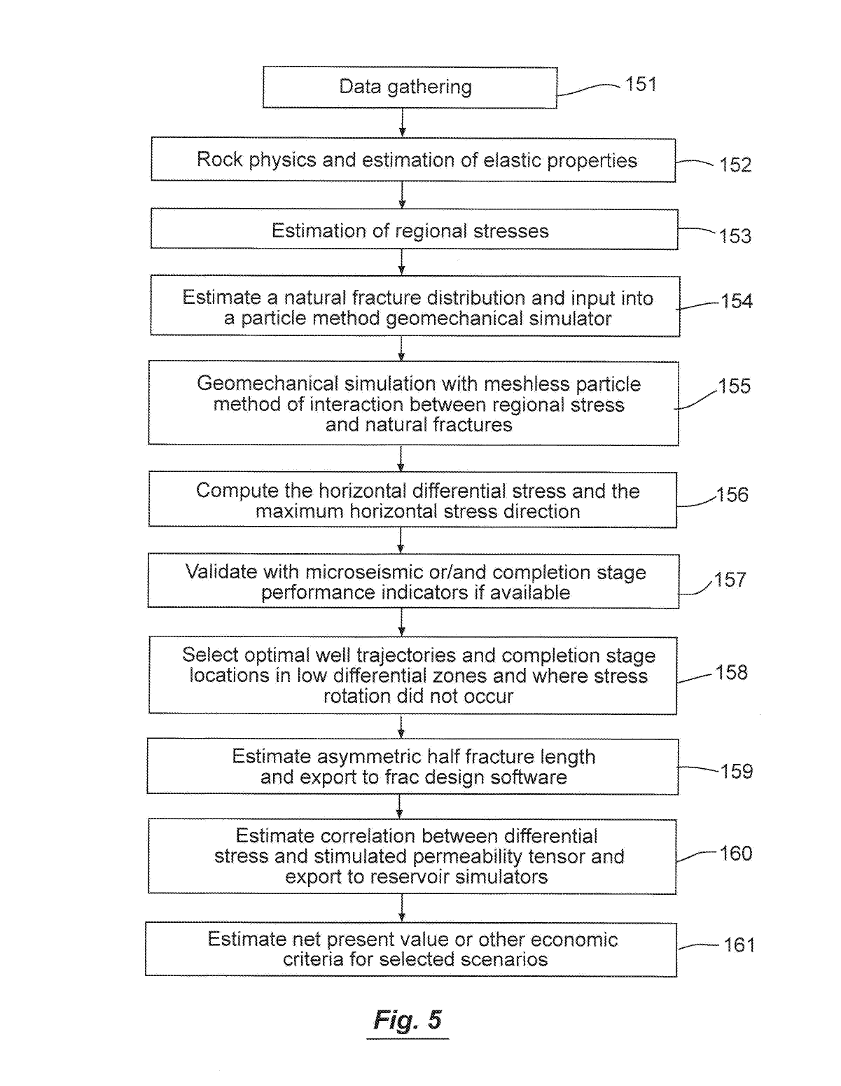

FIG. 5 is a flow chart of an exemplary method of hydraulic fracture design and completion optimization according to the present invention. In this regard, the method will be described with respect to various steps. Generally, the present invention aims to optimize hydraulic stimulation and wellbore completion designs prior to drilling and hydraulic fracturing of new wells through the use of a new geomechanical simulation and data typically available during field development (seismic, well data). The process involves multiple steps including data gathering, rock physics and estimation of elastic properties, regional stress estimation, natural fracture modeling, geomechanical simulation of regional stress interacting with natural fractures, computation of horizontal differential stress and maximum principal stress directions, validation with field data if available, selection of optimal well trajectories and positions for hydraulic fracturing stages, estimation of half-fracture lengths for hydraulic fracturing design software and estimation of stimulated permeability for reservoir simulation software. The data used is comprised of data such as well locations, drilling, logging, completion, fracturing, seismic, microseismic, and production data. A major advantage of the present invention is the ability to use a continuous fracture model to create an equivalent fracture model that will be used as input into a meshless particle-based geomechanical model to quickly simulate (i.e., in few hours) the interaction between the regional stress and the natural fractures represented by the equivalent fracture model. The resulting outputs of the present invention include the horizontal differential stress which can be used to optimize the position of the wellbores and hydraulic fractures to produce the highest production of hydrocarbons while keeping the drilling and completions costs to a minimum and reducing the impact on the environment by avoiding using excessive water and sand on completion stages that will not successfully produce hydrocarbon.

Data gathering is an important part of the method as many of the subsequent steps and analysis depend on the data gathered in step 151 of FIG. 5. To this end, data can be extracted from a variety of available sources. Examples of the various types of data that are commonly utilized will be described below, however, no limitation is intended. Rather, it is understood that the present invention can utilize essentially any type of information related to a field/reservoir or wells that can be quantified in some manner. Accordingly, one of ordinary skill in the art will recognize that extension of the present invention to types of data not explicitly described within the present disclosure is still within the scope of the present invention. Further, it is understood that data may come in various types of file formats, including imported data from proprietary databases found in commercial software, open databases, spread sheets, .pdf files, text files, ASCII files (e.g., LAS files designed for well logs), xml files, SEGY files (e.g., special ASCII files designed for seismic data) or combinations thereof. In this regard, it is also understood that the file formats include both common file formats and proprietary file formats. Generally, data obtained from any type of format may be utilized within the methods and systems of the present disclosure. Those of ordinary skill in the art will recognize that some file conversion or other processes are implemented in some instances to allow for the proper processing of the data from the various file formats within the context of the present disclosure. Accordingly, the details of such conversions and processing will not be described in detail herein.

In some instances, the data gathering step 151 includes gathering or obtaining well locations and deviations, and reservoir properties estimated from wireline logs such as gamma ray, density, resistivity, neutron, compressional and shear sonic, and image logs such as FMI, FMS, petrophysical interpretations leading to the estimation of porosity, water saturation, and core data providing measurement of total organic carbon (TOC), porosity, permeability, and fracture density. In some instances the data gathering includes geologic reports, geologic formations tops and 3D geocellular grids that will allow the identification of the boundaries of the geologic formations 103 and 104 in the wellbores. The 3D grids could be imported from existing reservoir modeling software or constructed using the geologic formations tops available in the existing wells, wireline logs, and seismic data and its interpretation if available.

In some instances, the data gathering step 151 includes gathering or obtaining seismic data and seismic attributes. The seismic data could be post-stack or pre-stack, and the seismic attributes could be derived from a multitude of post stack and pre-stack processes that include seismic resolution enhancement or bandwidth extension methods that allow the seismic signal to reach higher frequencies, seismic structural attributes such as coherency, similarity, volumetric curvature or any other seismic method that uses these seismic attributes to image faults and fractures, spectral decomposition methods that provide frequency dependent seismic attributes or any seismic attribute that combines multiple spectral attributes, post stack seismic inversion methods such as colored inversion, deterministic inversion, sparse spike inversion, generalized linear inversion, stochastic or geostatistical inversion, pre-stack seismic inversion methods such as extended elastic inversion, simultaneous pre-stack inversion, AVO methods, azimuthal anisotropy methods, shear wave velocity anisotropy methods, isotropic and anisotropic velocity models and all other seismic methods that use seismic data to provide information over a large reservoir volume that includes one or multiple wells.

In some instances, the data gathering step 151 includes gathering or obtaining drilling reports and measurements, such as rate of penetration, mud losses and information derived from mud logs such as total gas, gas chromatography measurements. Mud losses and gas chromatography measurements are commonly available data and could be utilized as a proxy of fracture density when there are no wireline, image logs and core data.

In some instances, the data gathering step 151 includes gathering or obtaining completion stimulation data. The completion data includes the position and depth of the perforation clusters, cluster per fracture stages, tubing size, completion time. The stimulation data includes treatment volumes and rates, completion stages, initial and final instantaneous shut-in pressure (ISIP), breakdown pressure, closure pressure, conductivity, fracture gradient or other information regarding stimulation.

In some instances, the data gathering step 151 includes gathering or obtaining microseismic or tiltmeter data and their interpretation, which could provide some indication on the geometry of the hydraulic fracture, direction of localized maximum horizontal stress, and in some instances information on the failure mechanisms and the orientation of the critically stressed natural fractures. In the proposed workflow to estimate initial geomechanical conditions, it is desirable to validate the predicted results by using interpreted and correctly positioned microseismic or tiltmeter data and events.

In some instances, the data gathering step 151 includes gathering or obtaining hydraulic fracture stage performance indicators such as production logs, tracer tests, fiber optics, that provide quantitative or qualitative information on the performance of each hydraulic fracture stage. In the proposed workflow to estimate initial geomechanical conditions, it is desirable to validate the predicted results by using one or multiple data that could be considered a fracture stage performance indicator.

In some instances, the data gathering step 151 includes gathering or obtaining well production rate and pressure, such as oil, water, and gas production rates, cumulative productions, estimated ultimate recovery, initial production of the first 30, 90 and 180 days, pressure and production decline parameters. These production and pressure data could be used in multiple ways including validation of the derived predicted results of workflow as well as natural fracture density proxy if there are no available wireline and image logs, petrophysical interpretation or core data to quantify the natural fractures at the wells. These production and pressure data are the result of the interaction of three major factors and their interaction resulting from the drilling, completion and stimulation of the considered well. These three factors are first the geologic heritage and the resulting resource represented by the rock porosity and the total organic carbon (TOC), second the plumbing or permeability created during the stimulation which depends in large part on the rock brittleness and the natural fractures, and third on the drilling, completion and stimulation design. The first two factors can be optimized by finding the geologic sweet spots where the best rock property that has the best combination of porosity, TOC, rock brittleness and natural fractures can be found. The third factor depends in big part on the geomechanical sweet spots where the horizontal differential stress is low and the localized maximum principal stress direction is perpendicular to the drilled wellbore. The workflow provides the geomechanical sweet spots which represents the initial geomechanical conditions that could be used to optimize the drilling, completion and stimulation design to achieve the highest well production while keeping the cost as low as possible by avoiding drilling and stimulating poor rock that will not produce or by adjusting the treatment to the surrounding geomechanical conditions.

In some instances, as part of the data gathering step 151, the collected data is processed to fit the needs of the subsequent steps of the method in FIG. 5. For example, many data types require quality control steps to remove noise and outliers that could introduce errors in the subsequent modeling steps of the method in FIG. 5. The outcome of the data gathering process 151 and the quality control applied to a data set that will include one or multiple wells that will have varying data collected during and after drilling, completion and stimulation as well as in some instances volumetric information represented by seismic, microseismic or tiltmeter data that provide information over a large area around one or multiple wells.

Returning to FIG. 5, with the data gathered at step 151, the method continues at step 152 with rock physics and estimation of elastic properties. In this step, the objective is to estimate the static elastic properties needed for the geomechanical modeling which include the Poisson's Ratio, Young's Modulus and density. In some instances the wireline and image logs, petrophysics interpretation, core data is not available at all or is available only in a limited number of wells. When the wireline logs and core data is not available in any well, step 152 can use published data or wireline log data from analogue fields or nearby wells until log data becomes available in the field 110. If the compression, shear sonic and density logs are available in wells 101 and 102, the dynamic elastic properties such as Young's Modulus and Poisson's Ratio are computed using established geophysical relationships. If static measurements of the elastic properties made in laboratory tests conducted on reservoir rocks are available, the dynamic elastic properties derived from the geophysical logs could be calibrated to the static measurements and used in the next steps of method in FIG. 5. If the laboratory static measurements of the elastic properties are not available, then published correlations or nearby well data could be used to estimate the adjustment factor needed to multiply the dynamic elastic properties.

The elastic properties derived at the wells 101 and 102 need to be propagated in the entire subterranean formation 104 and 103. This could be accomplished by using well data alone, or combining the available well data with seismic data, if available. If no seismic data is available, the elastic properties available in the wells 101, 102 and other possible wells in the field 110, could be distributed in the subterranean formations using deterministic, geostatistical, neural networks, or any other reservoir modeling method. When seismic data is available, it could be used to derive the distribution of the elastic properties in multiple ways. When pre-stack seismic is available, it can be used in pre-stack elastic inversion to derive directly the seismically derived compressional and shear velocity along with an estimate of the density which are then combined to form the seismically derived dynamic elastic properties. These dynamic elastic properties are adjusted to static measurements using the same procedure described for the adjustments applied to the elastic properties derived from well logs. If pre-stack seismic is not available, post stack seismic attributes could be used to guide the geostatistical or neural network based interpolation in the subterranean formation 104 and 103 of the elastic properties derived at wells 101, 102 and other possible wells in the field 110.

Referring again to FIG. 5, with the data gathered at step 151, the elastic properties estimated in the entire subterranean formations 104 and 103, the present method continues at step 153 with the estimation of the regional stresses. In this step, the objective is to estimate the vertical stress, the pore pressure and the magnitude and orientation of the regional horizontal stresses in field 101. This estimation depends on the available data in the field 101 or in nearby fields. For example, the different methods that can be used to compute these stresses and the data needed for each method are described in detail in the book by Mark Zoback entitled “Reservoir Geomechanics”, from Cambridge University Press (2010). A variety of conventional techniques for estimating these stresses and data are known in the industry.

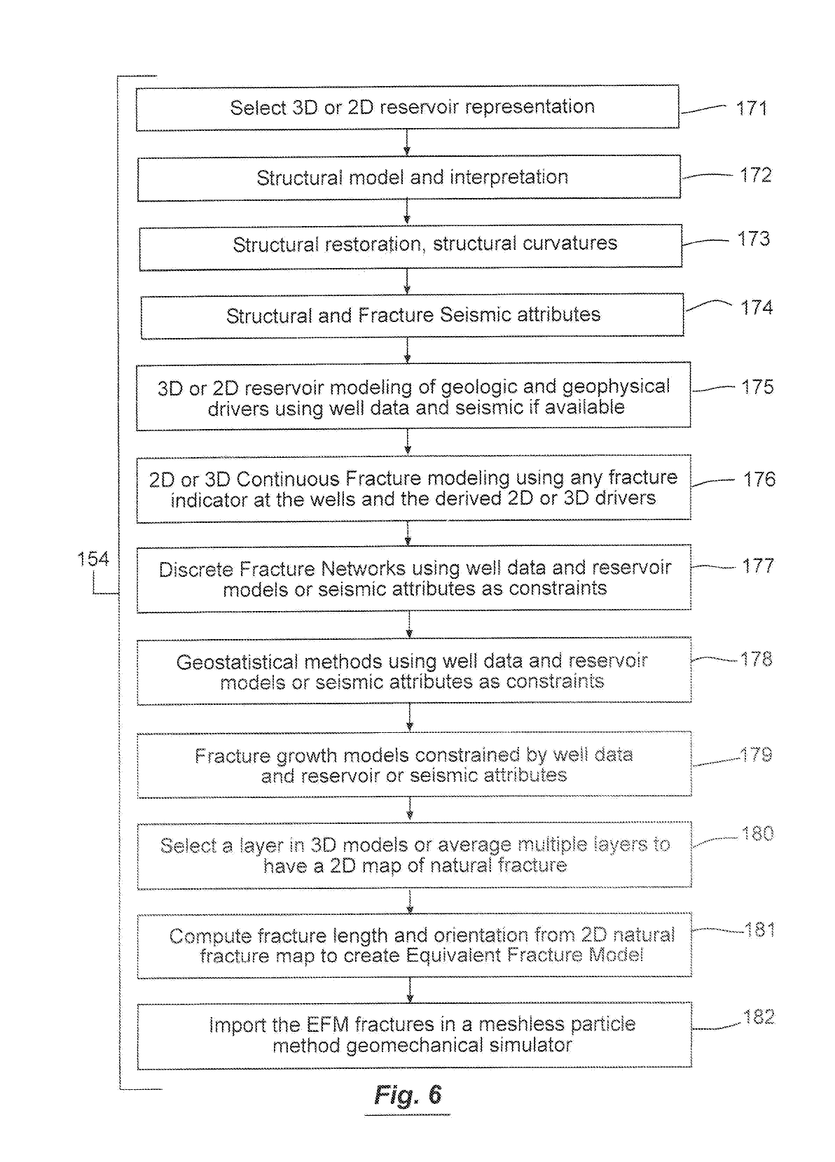

Referring again to FIG. 5, the present method continues at step 154 with the estimation of the natural fracture distribution shown in detail in FIG. 6. Since the natural fracture distribution is a key component of the invention, multiple methods can be used to determine the best natural fracture distribution possible given a set of available data. The process for finding the natural fractures, for example, in the naturally fractured subterranean formation 103, starts by selecting a three dimensional or two dimensional representation 171 of the considered reservoir volume. When using a three dimensional representation, the natural fractures could be represented by discrete planes or by an average characteristic of the natural fractures, such as fracture density, in a representative elementary volume. When using a two dimensional representation of the reservoir volume, the natural fracture density is approximated at a surface location 102 or 101 by an average value, such as hydrocarbon production rates, that could be used as a proxy for the combined effects of the complex three dimensional fracture network 109. When using either a three dimensional or two dimensional representation of the reservoir, the boundaries of the naturally fractured subterranean formation 103 can be represented by the structural model that includes the interpreted geologic boundaries derived by using seismic data or geologic reports and well tops.

Multiple methods can be used in this invention to determine the natural fracture distribution. The methods involve the use of one or more types of data and could require one or more processing steps. Among the methods that require minimal data and processes, the tectonics methods use the structural surfaces and their deformation to infer a fracture density that is assumed to be high where the structural geologic surface is highly deformed. The degree of deformation of the geologic surface is measured by computing the curvature on the current geologic structural surface or by the amount of strain generated while deforming a flat surface until it takes the shape of the current geologic structural surface. These methods through structural restoration and structural curvatures 173 could provide a distribution of the natural fractures in certain tectonics regimes but they are approximations that in some situations do not provide a realistic distribution of the natural fractures

Another method that provide fracture proxies in certain particular situations is the use of certain seismic algorithms applied to seismic data to provide structural or fracture seismic attributes 174. The structural seismic processing methods use the dip in the seismic data to compute the curvature, or compare the presence or absence of correlation between multiple nearby seismic traces. All the structural seismic attributes and the methods used to derive them from seismic data are described in great detail in the book by Chopra S. and K. Marfurt, entitled “Seismic Attributes For Prospect Identification and Reservoir Characterization,” published by the Society of Exploration Geophysicists and European Association of Geoscientists and Engineers (2007). Examples of seismic processing algorithms that attempt to image directly the natural fractures are described in great detail in the book by Liu, E. and Martinez, A., entitled “Seismic Fracture Characterization”, published by EAGE Publications by (2013). When fracture information from well data is not available or not sufficient and only seismic data is available, the present invention can use the structural seismic attributes as a proxy for the distribution of the natural fractures.

One method that is able to derive a 2D or 3D distribution of the natural fractures relies on the use of geologic and geophysical drivers which represent reservoir properties that are known to impact the degree of natural fracturing. For example, brittle reservoirs tend to have more fractures than ductile rocks that could deform without breaking and creating fractures. In addition to brittleness of the rock, the thickness of the fractured subterranean formation 103 is another well recognized fracture driver whereas thinner parts will have more natural fractures than thicker parts. In this context, the estimation of the natural fractures as a continuous property derived in the entire 2D or 3D study area requires the estimation of the geologic and geophysical drivers that could be computed directly from seismic data, or estimated in 2D or 3D by combining the available well logs and core data with the available seismic data and derived seismic attributes. This estimation of the continuous fracture drivers in the entire 2D or 3D study area can be achieved by using the existing deterministic interpolation methods, geostatistical methods, neural networks or any other reservoir modeling method able to propagate the limited well data in the entire 2D or 3D study area.

Once the geologic and geophysical drivers are available over the 2D or 3D study area, the natural fracture density available at the wells and measured from wireline and image logs, petrophysical interpretations and core data, from drilling reports, or from well production can be propagated to create a continuous natural fracture density defined in the entire 2D or 3D study area by using artificial intelligence tools such as neural network in the methodology described by Ouenes, A., “Practical Application of Fuzzy Logic and Neural Networks to Fractured Reservoir Characterization,” Computer and Geosciences, 26, 953-962 (2000). This artificial intelligence workflow will find the geologic relationship that relates the continuous drivers available in the entire study area with the natural fracture defined in a 3D representation along the wellbores 105, 106 or in a 2D representation at the well locations such as 101 and 102. Once this geologic relationship is found and validated with existing well data, it will be applied over the entire study area to predict the continuous natural fracture density or its proxy defined using wireline logs, drilling reports measurements such as mud losses, or well performance derived from well production.

Referring again to FIG. 6, the method 154 continues at step 177 where the natural fracture could be represented by discrete fracture planes and estimated using a statistical method that uses the available fracture statistics available at the wells. The discrete fracture network will attempt to honor the fracture statistics available at the wells as well as a continuous natural fracture property such as the one derived in step 176 or a seismic structural attribute 174 to guide the distribution of the discrete fracture network as described in Ouenes, A., and Hartley, L. J., “Integrated Fractured Reservoir Modeling Using Both Discrete and Continuum Approaches,” Society of Petroleum Engineers. doi:10.2118/62939-MS (2000).

Referring again to FIG. 6, the method 154 continues at step 178 where the natural fracture model could be distributed in the 2D or 3D study area using geostatistical methods that rely mainly on the natural fracture statistical information derived at the wells as illustrated by J.-P. Chilès, “Fractal and Geostatistical Methods For Modeling Of A Fracture Network,” Mathematical Geology, 20(6):631-654 (1988). The geostatistical methods used to distribute the natural fractures could be constrained by additional information such as seismic data as illustrated by Liu, X., Srinivasan, S., and Wong, D., “Geological Characterization Of Naturally Fractured Reservoirs Using Multiple Point Geostatistics,” Society of Petroleum Engineers. doi:10.2118/75246-MS (2002).

Referring again to FIG. 6, the method 154 continues at step 179 where the natural fracture model could be derived with a growth model as shown by Olson, J. E, “Joint Pattern Development: Effects Of Subcritical Crack Growth And Mechanical Crack Interaction,” Journal of Geophysical Research, 1993, Volume 98, Issue B7, p. 12251-12265. These growth models could also be combined with geostatistical methods and discrete fracture networks as illustrated by Bonneau, F., Henrion, V., Caumon, G., Renard, P., Sausse, J., “A Methodology For Pseudo-Genetic Stochastic Modeling Of Discrete Fracture Networks,” Computers & Geosciences, 2013, 56, 12.

Referring again to FIG. 6, the method 154 continues at step 180 where the 3D natural fracture model defined in a continuous way in step 176 or approximated with a structural seismic attribute 174, or estimated from structural restoration resulting strain or a structural curvature 173 needs to be extracted along a structural horizon close enough to the wellbore 108, or averaged in an interval encompassing the wellbore 108 and inside the subterranean formation 103. The resulting averaging process or selection along a structural horizon will lead to the availability of a 2D map of natural fracture density or one of its proxies. In a 3D problem, multiple 2D maps are extracted at different depths and used sequentially in the proposed invention to create a 3D volume of differential stress.

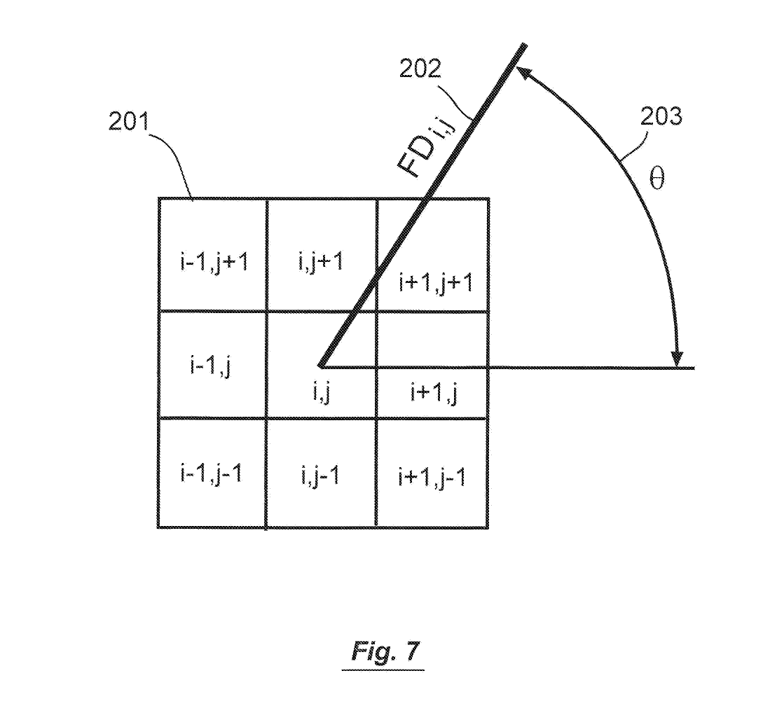

Referring again to FIG. 6, the method 154 continues at step 181 where the continuous scalar 2D map natural fracture model derived in step 180 is converted to an equivalent fracture model representing a vectorial map where at each location on the map will have a fracture length and fracture orientation computed using either the weighting method described by Zellou, A. M., Ouenes, A., and Banik, A. K., “Improved Fractured Reservoir Characterization Using Neural Networks,” Geomechanics and 3-D Seismic., Society of Petroleum Engineers. doi:10.2118/30722-MS (1995, Jan. 1) or any other method described by Fisher N., I., “Statistical Analysis Of Circular Data,” Cambridge University Press (1996). This step 181 is one of the fundamental elements of the present invention, wherein any 2D map scalar representation of the distribution of the natural fractures density or any proxy that could represent natural fracture density is converted to a set of fracture segments that have a certain length and orientation. Given the importance of this step in the present disclosure, the details of this step is illustrated by using the weighting method, but any other circular statistical method could be used to achieve the same goal of transforming a scalar 2D map of fracture density into an equivalent fracture model made of fracture segments characterized by a length and an orientation. Referring to FIG. 7, the weighting method is illustrated by considering a subset of a 2D grid centered on the cell (i,j) and divided into discrete cells labeled by their coordinates i and j 201, where the fracture density at cell (i,j) is labeled FD (i,j) is represented by a segment which has a length L(i,j) 202 and an angle theta (i,j) 203. The length L(i,j) is given by the formula:

L(i,j)=1.5 pow[10×(FD(i,j)/max FD(i,j))]

Where max FD(i,j) represents the maximum value of the fracture density in the entire 2D grid. The angle theta (i,j) of the equivalent fracture is given by the formula:

Theta(i,j)=Arcsin {F(i,j)/sqrt [F(i,j)*F(i,j)+E(i,j)*E(i,j)]}

Where E(i,j)=A (i,j)*0.707+B(i,j) and F(i,j)=C(i,j)*0.707+D(i,j)

### Where:

A(i,j)=FD(i+1,j+1)−FD(i−1,j−1)+FD(i+1,j−1)−FD(i−1,j+1)

B(i,j)=FD(i+1,j)−FD(i−1,j)

C(i,j)=FD(i+1,j+1)−FD(i−1,j−1)+FD(i−1,j+1)−FD(i+1,j−1)

D(i,j)=FD(i,j+1)−FD(i,j−1)

Referring again to FIG. 6, the method 154 continues at step 181 with the 3D natural fracture model. If a discrete fracture network 177 or fracture growth model 179 was used to generate the natural fracture distribution in 3D, the 2D natural map is found by taking the intersection between the structural horizon close to the wellbore 108 with the 3D discrete natural fracture model. The resulting intersection provide the equivalent fracture model needed for the next step 182 where the natural fracture information is input in a meshless particle-based geomechanical simulator.

Referring again to FIG. 6, the method 154 continues at step 182 where the equivalent fracture model is used to convert the natural fracture segments derived in the equivalent fracture model into particles that will be used in a meshless particle-based method such as the material point method or any similar particle method. The explicit discretization of a segment representing a natural fracture into particles is illustrated by Nairn, J. A., “Material Point Method Calculations with Explicit Cracks,” Computer Modeling in Engineering & Science, 4, 649-66, 2003. Since the use of a meshless particle-based geomechanical simulator and its ability to use as input the derived equivalent fracture is a key element of the present invention, more details are given on a particular particle-based method called the Material Point Method (MPM) and the publicly-available software that can be used to implement the invention.

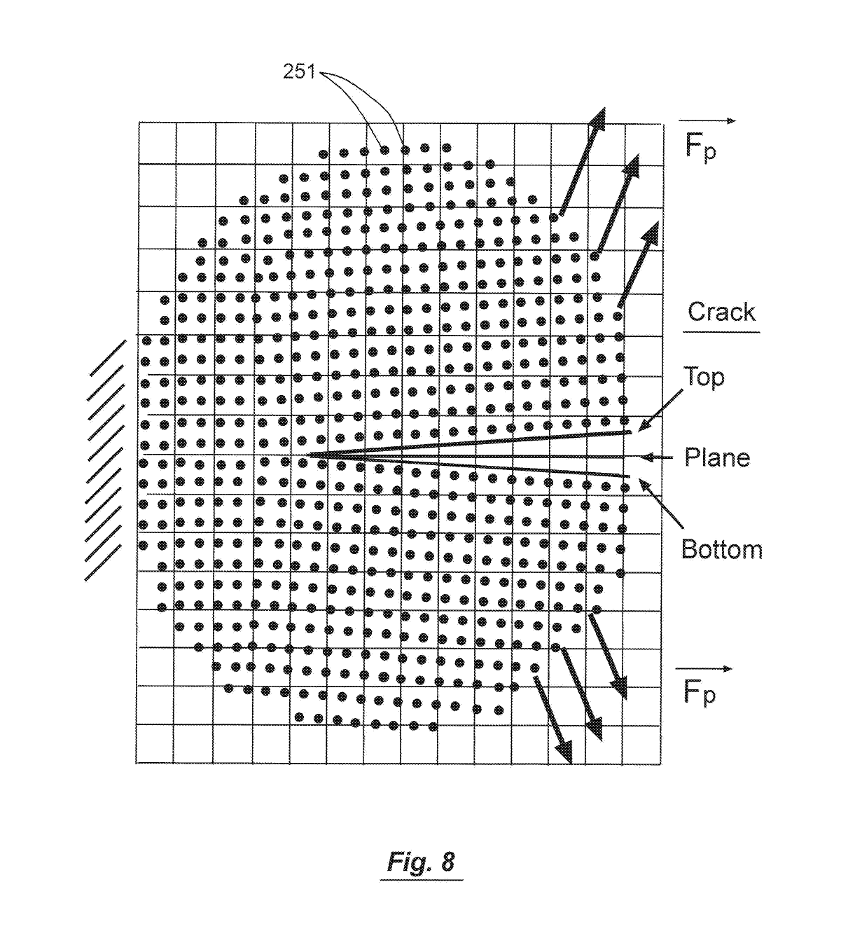

The Material Point Method (MPM) is a meshless method developed by Sulsky, D., Z. Chen, and H. L. Schreyer, “A Particle Method For History-Dependent Materials,” Computer Methods in Applied Mechanics and Engineering, 118, 179-196 (1994), as a potential tool for numerical modeling of dynamic solid mechanics problems. It represents an alternate approach, with alternate characteristics, for solving problems traditionally studied by dynamic finite element methods. In MPM, a material body is discretized into a collection of points 251, called particles as shown in FIG. 8. A background grid is associated with the particles; it is composed of cells. Solid body boundary conditions are applied to the grid or on the particles. The background grid is only used as a calculation tool space for solving the equations of motion. At each time step, the particle information is extrapolated to the background grid, to solve these equations. Once the equations are solved, the grid-based solution is used to update all particle properties such as position, velocity, acceleration, stress and strain, state variables, etc. This combination of Lagrangian (particles) and Eulerian (grid) methods has proven useful for solving solid mechanics problems. It has been shown to be especially useful for solving problems with large strains or rotations and involving materials with history-dependent properties such as plasticity or viscoelasticity effects.

One potential application of MPM is dynamic fracture modeling as shown by Nairn, J. A., “Material Point Method Calculations with Explicit Cracks”. Computer Modeling in Engineering & Science, 4, 649-66, 2003. To handle explicit fractures such as the ones developed with the equivalent fracture model, MPM was extended by Nairn using the CRAMP (CRAcks in the Material Point) algorithm. Both the particle nature and the meshless nature of MPM makes CRAMP well suited to the analysis of problems in fractured media. In 2D MPM, fractures are represented by a series of line segments as computed in the equivalent fracture model. The endpoints of the line segments are massless material points, called fracture particles. By translating the fracture particles along with the solution, it is possible to track fractures in deformed or translated bodies. The fracture particles also track crack-opening displacements that allow for calculation of fracture surface movements. The fracture particles influence the velocity fields on the nearby nodes in the background grid. In addition, CRAMP fully accounts for fracture surface contact, is able to model fractures with frictional contact, can use fractures to model imperfect interfaces, and can insert traction laws to model cohesive zones, or input pressure.

The CRAMP algorithm models displacement discontinuities in fractured media by allowing each node near the fracture to have two velocity fields representing particles above and below the fracture as shown in FIG. 8. The disclosure uses the publically available MPM software Nairn-MPM-FEA that can be downloaded from https://code.google.com/p/nairn-mpm-fea.

Although the particle method is the preferred technique to do the geomechanical simulation of the effect of the regional stress on the natural fractures, it should be understood that other techniques could be employed. Possible alternative geomechanical methods include finite elements, finite difference, extended finite elements, or any discretization scheme suitable for solving continuum mechanics equations.

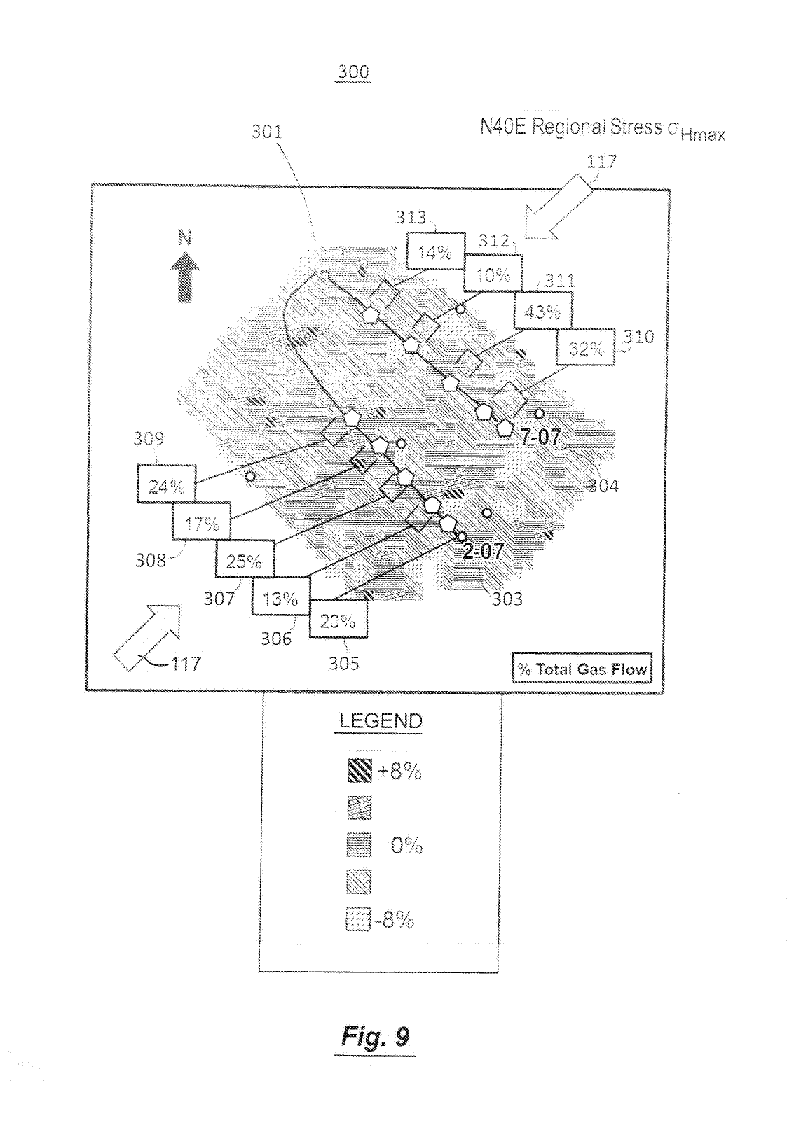

Referring again to FIG. 5, with the natural fracture distribution completed and the resulting equivalent fracture model discretized into particles and input into a meshless particle-based geomechanical simulator, the method continues at step 155 where the interaction between the derived regional stress 153 and the natural fracture distribution 154 will be simulated. The disclosed methods are described using information from an actual shale reservoir. The area that was selected as part of this study is called the Pouce Coupe field located in Northwest Alberta and the target fractured subterranean formation is the Montney shale which has been divided in six sub-units labelled from A to F. One of the major characteristics of this study is the availability of a 4D multicomponent seismic survey that was acquired in December 2010. A two-well pad 300 shown in FIG. 9 is the focus of the study. Well 2-07, 303 is completed with five hydraulic fracturing stages in the lower Montney C, while well 7-07, 304 is completed in the upper Montney D also with five hydraulic fracturing stages. Sliding sleeves with same proppant concentration and pumped volumes were used in both wells. Prior to any stimulation of the two key wells, a baseline 3D multicomponent surface seismic survey was acquired. This first survey was followed by two time-lapse 3D multicomponent monitor surveys, the first after the hydraulic fracturing of the well 2-07 completed in the Montney C and the second after hydraulic fracturing of well 7-07 completed in the Montney D. Microseismic data were acquired to monitor the stimulation across the five stages completed in each well. Spinner production logs provided the contribution of each frac stage 305, 306, 307, 308, 309, 310, 311, 312 and 313 to the total first year gas production, which was 19,884 m³ in the 2-07 well and 14,074 m³ in the 7-07 well. The maximum horizontal stress direction 117 is about N40E and due to the proximity to the Rockies a high stress anisotropy (defined as the maximum horizontal stress divided by the minimum horizontal stress) of 1.8 is observed in the study area. The stress regime allows a strike-slip failure since the maximum horizontal stress is greater than the vertical stress which in turn is greater than the minimum horizontal stress. The time lapse seismic data was processed using a technique called Shear Wave Velocity Anisotropy (SWVA) that attempts to image directly the natural fractures from the seismic data. The results of the SWVA processing was presented by Grossman, J. P., Popov, G., Steinhoff, C., “Integration Of Multicomponent Time-Lapse Processing And Interpretation: Focus On Shear-Wave Splitting Analysis,” The Leading Edge, (January 2013) and includes the last SWVA map 301 derived after the stimulation of well 7-07 and shown in FIG. 9.

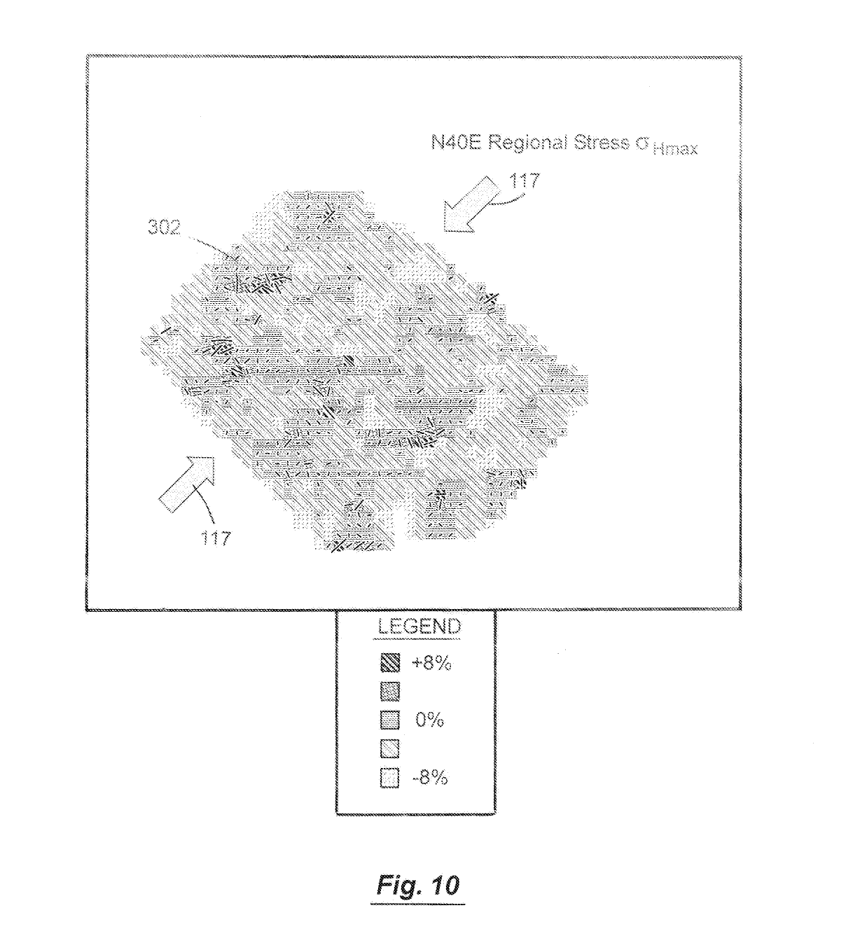

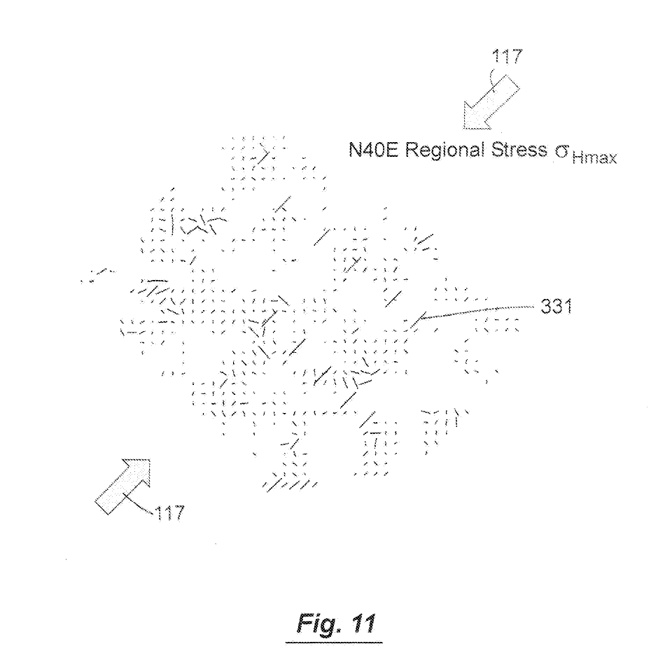

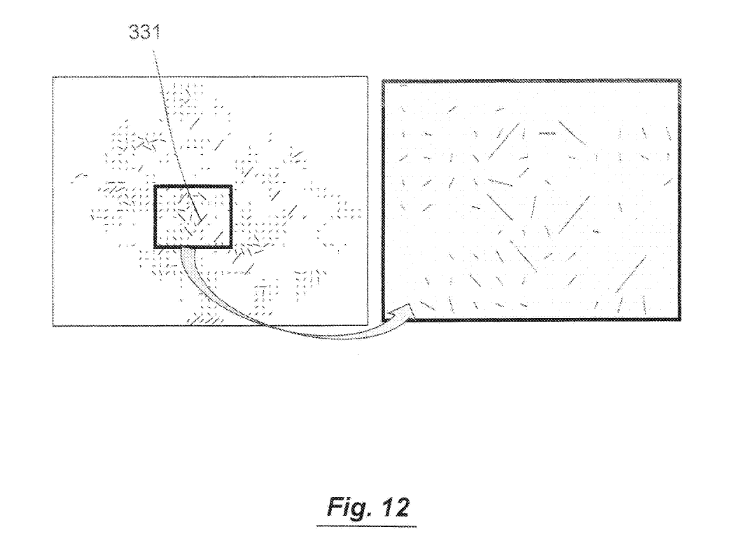

Referring to FIG. 9, we will assume that the last SWVA map 301 derived after the stimulation of well 7-07 is a seismic attribute 174 (FIG. 6), that could be a reasonable proxy for natural fracture density distribution 154. Applying the methods described in FIG. 6 in step 181, the SWVA map is converted into an equivalent fracture model 302 as shown in FIG. 10. The regional stress 117 will be applied to the equivalent fracture model 302. The resulting equivalent fracture model 302 where each natural fracture is represented by a length and orientation is imported in a particle-based geomechanical simulator able to discretize the natural fractures into particles 331 as shown in FIGS. 11 and 12. The particle-based geomechanical simulator uses the 2D plane strain theory to solve numerically the momentum equation in the presence of the regional stress 117 representing the main boundary condition. The regional stress boundary conditions 117 are applied to the study area 331 by simulating the compression over a time period that is sufficient to achieve quasi-equilibrium. An example of particle-based geomechanical simulator is described by Aimene, Y. E., and Nairn, J. A., “Modeling Multiple Hydraulic Fractures Interacting with Natural Fractures Using the Material Point Method,” Society of Petroleum Engineers. doi:10.2118/167801-MS (2014, Feb. 25).

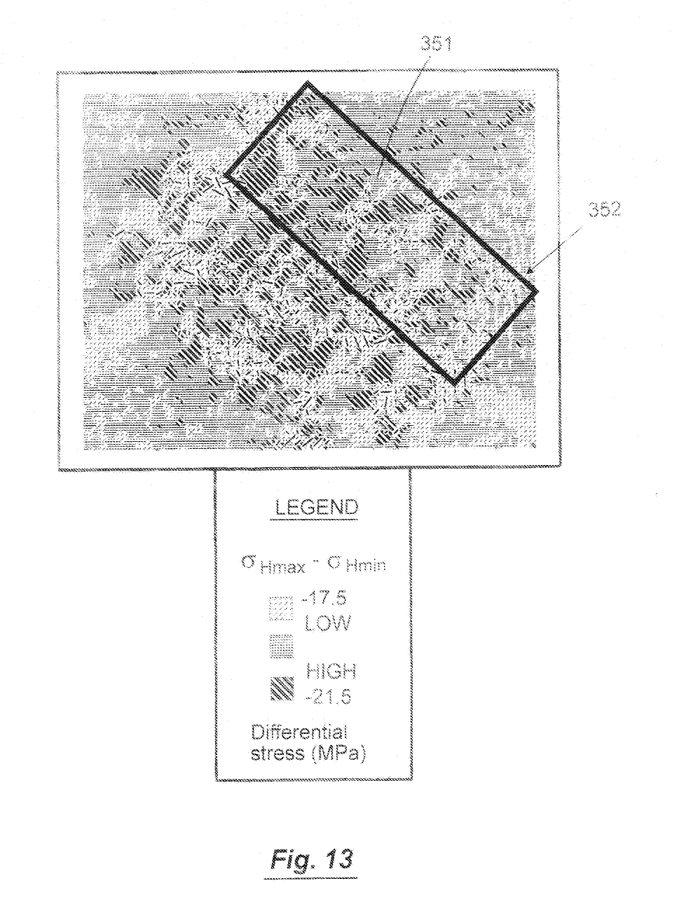

Referring to FIG. 5, the stress and strain results derived at quasi-equilibrium for each particle in the meshless particle-based geomechanical simulation, the method 150 continues at step 156 to compute the horizontal differential stress and the maximum principal stress direction. The geomechanical simulator outputs the differential stress 351 which represents the difference between σ_{Hmax}, the maximum horizontal stress and σₕₘᵢₙ the minimum horizontal stress computed as shown in FIG. 13. The resulting differential stress map 351 shows areas colored in black where the differential stress is high thus preventing the development of hydraulic fracturing complexity that is frequently responsible for good well performance. To illustrate the impact of the differential stress on the resulting production from each completion stage and microseismicity, an area 352 around well 7-07 (reference number 304) is considered for validation step 157 in FIG. 5.

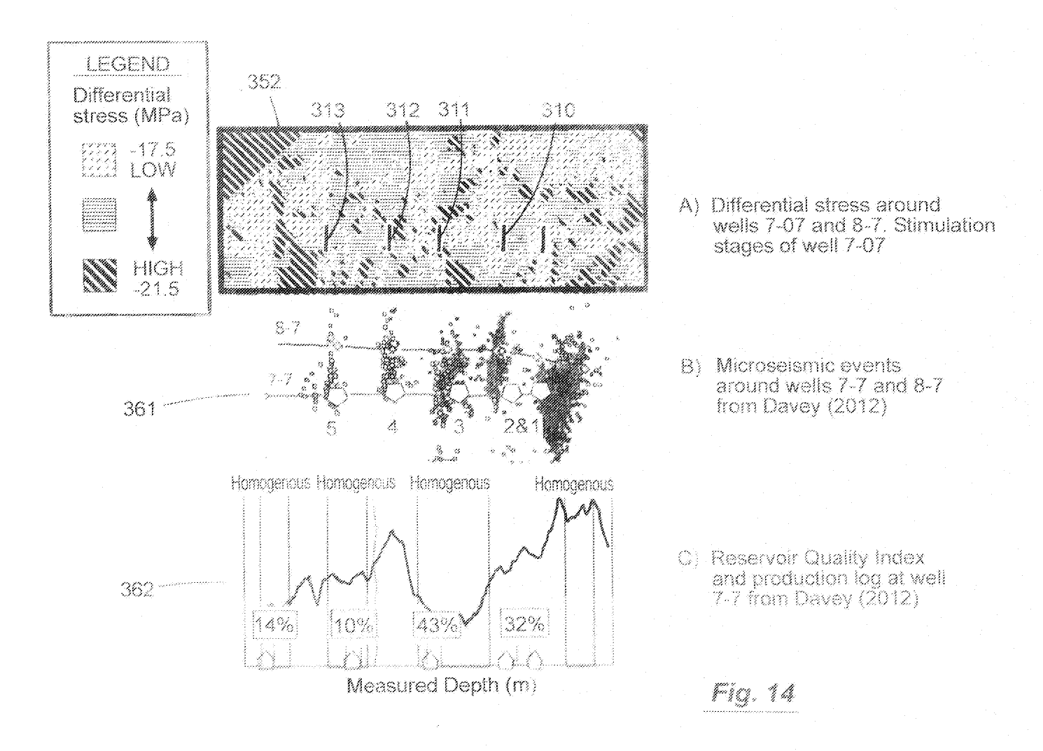

Referring to FIG. 14, the differential stress map of this area 352 with its completion stages 310, 311, 312, and 313 is compared to the available microseismic data 361 and the production performance by completion stage 362 indicating that the two first completion stages 310 produce 32% of the well total production, the completion stage 311 produces 43% of the well total production, the completion stage 312 produces only 10% of the well total production, and the last production stage 313 produces 14% of the well total production. The differential stress map 352 shows that the first three stimulation stages 310, and 311, are predominantly in a low differential stress area which could explain the dense microseismicity 361 in these stages. On the other hand, the high differential stress observed in completion stages 312 and 313 coincide with linear microseismic events 361 and low contribution to the total well production 362. This validation step is only included in the workflow in FIG. 5 when properly interpreted microseismicity or any completion stage performance indicator is available. If these data are not available, then this step is skipped and the workflow continues to step 158.

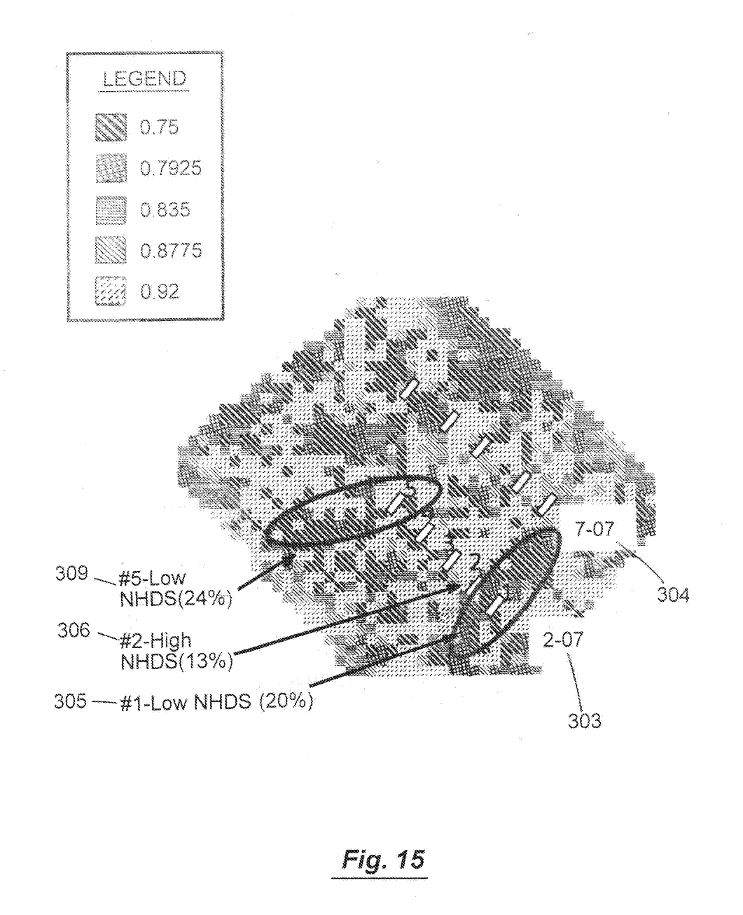

Referring to FIG. 15, the differential stress could be normalized to provide two key properties: the Normalized Differential Horizontal Stress (NDHS) and the Maximum Principal Stress Direction (MPSD). The NDHS is defined as:

NDHS=(σ_{Hmax}−σ_{Hmin})σ_{Hmin}

Where σ_{Hmax} is the maximum horizontal stress and σ_{Hmin} is the minimum horizontal stress. FIG. 15 shows a two-dimensional graph of the Normalized Differential Horizontal Stress (NDHS). Zones having low NDHS values could be considered the most favorable areas for hydraulic fracturing. When considering the well 2-07 303, the first completion stage 305 with a production log showing a contribution of 20% and completion stage 5, 309, with a high production of 24% show a low NDHS region highlighted by an ellipse. On the other hand, the completion stage number two, 306, is surrounded by a high NDHS and has the lowest production contribution of only 13%. This validation step is only included in the workflow 150 when properly acquired and interpreted microseismicity or any completion stage performance indicator is available. If these data are not available, then this step is skipped and the workflow continues to step 158.

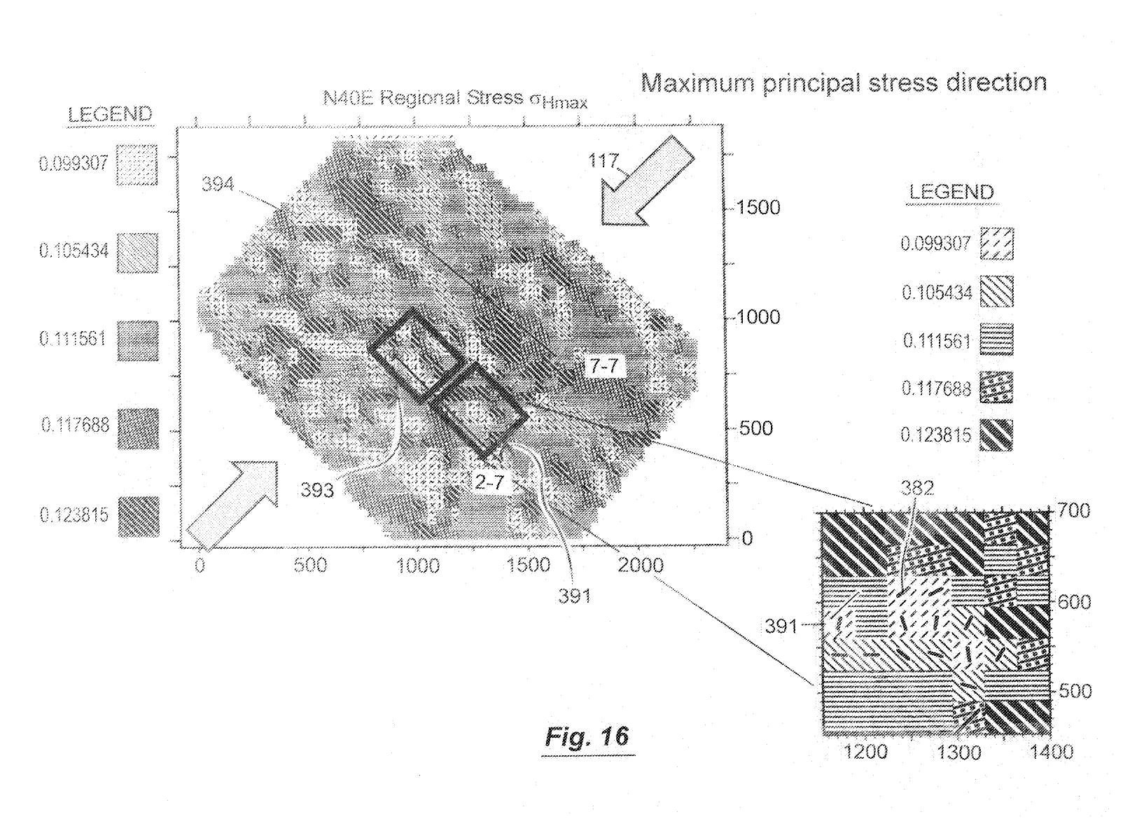

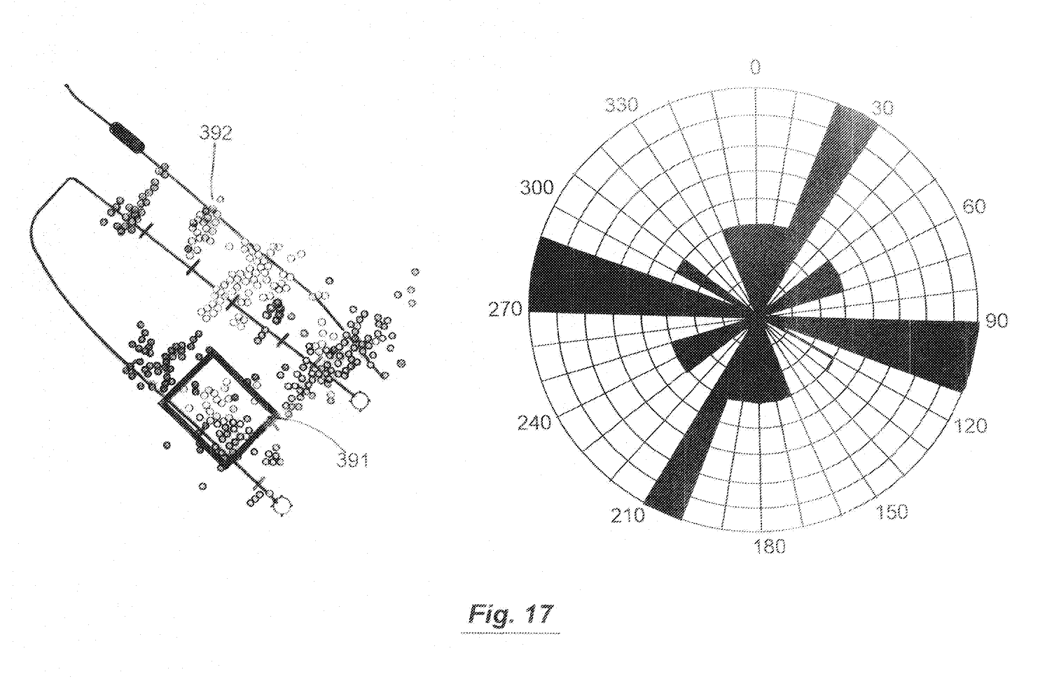

To better understand the preferred orientations taken by hydraulic fractures during stimulation we compute the Maximum Principal Stress 394 shown in FIG. 16. To find the local preferred direction a hydraulic fracture will follow, we apply the same approach described in 181 and shown in FIG. 7 to turn a scalar map into a vectorial property called the Maximum Principal Stress Direction (MPSD). On each Maximum Principal Stress 391 cell in FIG. 16, a black line is used to plot the maximum principal stress direction (MPSD) 382. The orientation of each line 382 represents the local orientation that a hydraulic fracture will prefer to follow. FIG. 17 is a local rose diagram taken in an area 391 illustrating the circular statistics for all orientations of the MPSD in the localized area 391 shown in FIGS. 16 and 17. In addition to the imposed regional stress of N40E, we find in certain areas a deviation from the regional stress direction N40E, and stress rotations which could reach almost 90 degrees as indicated in the rose diagram in FIG. 17. These local stress rotations could inhibit transverse development of some hydraulic fracturing stages and create more axial and longitudinal hydraulic fractures thus highlighting the importance of deriving these results before drilling and fracing.

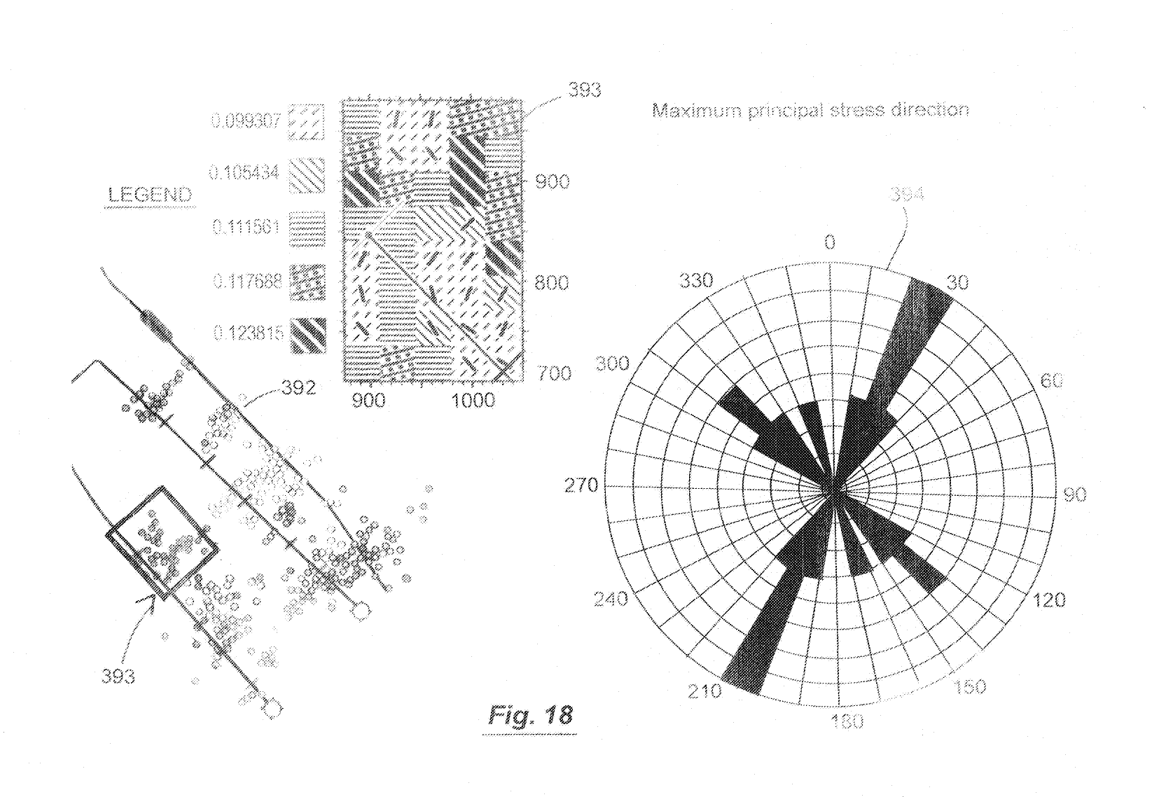

Referring to FIG. 16, the local maximum horizontal stress directions 382 could be validated with microseismicity data, if available. If we consider in the local MPSD data in a rectangular area 391 near completion stage three, 307, of well 2-07 and the same area in the microseismic data 392 in FIG. 17, we notice that the computed MPSD lines are predominantly oriented perpendicular to the regional maximum horizontal stress direction 117, which represents a local stress rotation of 90 degrees. This stress rotation is confirmed with the microseismic data 392 showing that the microseismic events in the rectangular area 391 are also predominantly oriented perpendicular to the regional maximum horizontal stress direction 117 thus validating the computed MPSD in the rectangular area 391. Similar observation could be made in rectangular area 393 near stage 5 309 in FIG. 18 where the rose diagram 394 shows another rotation angle. This validation step of the MPSD is only included in the workflow when properly interpreted microseismic data are available. If these data are not available, then this step is skipped and the workflow continues to step 158.

Returning to FIG. 5, the differential stress (NDHS) and MPSD are validated in step 157 if microseismic or completion stage performance indicators are available. The next steps 159-161 in FIG. 5 are to use these results in various applications. In particular, multiple completion design problems could be addressed using the differential stress (NDHS) and MPSD available for one or multiple subterranean formations 104 or 103. For example when selecting the position of the drilling pads where multiple wellbores will be placed, we define first the range of differential stress that constitute favorable drilling and hydraulic fracturing conditions. The normal prevailing differential stress without the presence of natural fractures is the uniform background differential stress. We consider that a low differential stress state could be achieved when the presence of the natural fractures creates a differential stress range of values between the background uniform value and 20% less. For example, if the uniform background differential stress is −13 MPa, then a low differential stress range could be between −13 Mpa and −10.4 MPa. When using the NDHS, the uniform background NDHS constant value is given by:

NDHS=(σ_{Hmax}/σₕₘᵢₙ)−1=Regional Stress Anisotropy−1

For example in the Montney shale case study shown in FIG. 9, the regional stress anisotropy is equal to 1.8 therefore the regional NDHS is equal to 0.8. An area with a low NDHS value is any area on the NDHS 2D map provided by the present disclosure where the local value on the NDHS is below this regional value of 0.8. It is this area that could favor the successful hydraulic fracturing.

Given this definition of what constitutes a low differential stress area, the total area of low differential stress 351 or low NDHS 382 could be computed in each subterranean formation 104 and 103 and used as a criteria to position the pad in the field 110. The subterranean formation with the largest area with the low differential stress could provide more opportunities for successful drilling and hydraulic fracturing. Once a pad area selected, the results could also be used for the optimal landing zone by comparing the area of low differential stress or low NDHS in each subterranean formation. The subterranean formation with the largest area of low differential stress or NDHS could yield better hydraulic fracturing results. For illustration purposes we assume that applying this criteria leads to the formation 104 being the optimal one with the largest area with low differential stress as compared to formation 103. Given a selected landing zone, the length and azimuth of the wellbore 108 could be adjusted to intercept mostly the low differential stress or NDHS zones. This optimal length of the wellbore is achieved by computing the total wellbore length that is intersecting the low differential stress areas. Multiple planned well lengths could be compared by ranking their lengths of intersecting low differential stress areas. Current wellbores are mostly drilled perpendicular to the regional stress 117 but as illustrated with FIG. 16 and FIG. 18 stress rotations could occur and prevent the development of transverse hydraulic fractures. To increase the likelihood of developing transverse hydraulic fractures, the azimuth of the wellbore could be designed in such a way that allows the wellbore to intersect perpendicularly as many localized maximum horizontal stress directions available in the MPSD map. This optimal selection of well trajectory and azimuth is achieved by computing at each intersected cell of the MPSD 2D map the angle difference between the regional stress and the local maximum horizontal stress directions and summing all the angle values along the planned wellbore. The best well trajectory from the perspective of MPSD and the development of transverse hydraulic fractures will be the well which has the lowest summed angle difference.

The differential stress, NDHS and MPSD available in the optimal subterranean formations 104, can also be used to optimize the pad location, the landing zone, and the wellbore length and azimuth in preparation for the placement of hydraulic fractures which also could have their position also optimized based on their differential stress or NDHS and the MPSD. The differential stress or the NDHS could be used to position the spacing between the hydraulic fracturing stages. For example, a high differential stress zone between completion stage 121 and 122 could be avoided by increasing the spacing between completion stage 121 and 122 or combining two planned stages into a single completion stage 121 with an adapted hydraulic fracturing treatment. If the differential stress or NDHS is low in the area where completion stage 122 and 123, closer spacing that avoids stress shadowing effects could be designed to access a larger stimulated reservoir volume. Given the MPSD, the treatment design for each of the completion stages could be adjusted accordingly. When the MPSD indicates the presence of stress rotations, the hydraulic fracturing design and execution must take into account the possibility of developing longitudinal hydraulic fractures. For wells already drilled and hydraulically fractured the stress field has been altered by the initial hydraulic fracturing and the ensuing production of hydrocarbons which could be lower than expected due to proper placement of well trajectory or completion stages thus making them candidate for hydraulic refracturing. In the absence of any measurement or model of the current stress field or the depleted zones, the differential stress or NHSD could be used to select refracturing candidates and completion stages. Current wells found to be drilled and completed in high differential stress zones could be the first refracturing candidates. When considering the refracturing of a limited number of completion stages, the high differential stress or NDHS zones could be used as the primary refracturing targets since the low differential zones or low NDHS zones have most likely benefited from the initial hydraulic fracturing.

The differential stress, NDHS and MPSD after being used to select pad locations, landing zones, well length and azimuth, and the spacing between completion stages could provide useful quantitative information to other software routinely used in hydraulic fracturing design and reservoir simulation. Most of the hydraulic fracture treatments are designed with hydraulic fracturing design software that do not take into account the presence of the natural fractures and their impact on the asymmetric behavior of the hydraulic fractures that do not grow the same length from both sides of the wellbore and do not necessarily follow the regional stress direction but rather the localized maximum horizontal stress direction that can be predicted and validated with the MPSD map. When considering a wellbore and hydraulic fracture stages, the resulting stimulated volume depends on the differential stress or the NDHS and the MPSD. Referring to FIG. 4, the extent of the hydraulic fracture 121 on each side of the wellbore could have different lengths 131 and 130. These same fracture half-length are usually the result of the hydraulic fracturing design software that unfortunately do not incorporate the effects of the local stress rotation and the effects of variable differential stress. In some instances the results of the disclosed invention available in the differential stress or NDHS could help the hydraulic fracturing design engineer adjust its treatments design. For hydraulic fracturing design software that allow the possibility to have instead of symmetric bi-wings two different half fracture lengths 131 and 130, oriented in any direction instead of being only along the regional stress 117, the extent of the low differential stress or NDHS around a completion stage 121 could provide the maximum possible lengths 131 and 130 on each side of the wellbore 108. For example if completion stage 121 has a high differential stress zone south of wellbore, the largest half-length 130 could be the distance from the wellbore to the high differential stress zone. The orientation of the half fracture length 130 could be oriented along the local maximum horizontal stress direction provided by the MPSD. In other instances the low differential stress or NDHS north of the wellbore allows for the growth of a fracture half-length 131 which represents the distance between the wellbore and the beginning of the high differential stress zone which is farther in the north side than in the south side of completion stage 121. Given the input of maximum half lengths provided by the differential stress or NDHS and the orientation provided by the MPSD, the hydraulic fracturing design engineer could optimize the design of treating completion stage accordingly by changing some of his design parameters such as leak-off coefficient, proppant concentration or injection rate to not exceed the hydraulic fracture length provided by the present invention.

The differential stress, NDHS and MPSD after being used to assist with hydraulic fracturing design software that could input variable half-length on each side of the wellbore and that could orient the hydraulic fracture in any direction, the present disclosure could in some instances provide input to reservoir simulation software. Most of the current simulation of stimulated unconventional reservoir assumes the same rectangular area around each hydraulic fracture along the entire wellbore. When microseismic data is available, the stimulated volume used in reservoir simulation is adjusted according to the interpreted microseismic data. Unfortunately, microseismic data is rare in unconventional wells but the present disclosure could remediate to this shortcoming by providing the potential extent of the stimulated area which is most likely going to be limited to the low differential stress or NDHS areas around the wellbore. This is achieved by simply creating an area in the vicinity of the wellbores where low differential stress and NDHS values are present and inputting this area in the reservoir simulation software as the potential stimulated reservoir rock that will have a higher permeability value as the result of hydraulic fracturing. These low differential areas input in reservoir simulation software provide the opportunity to represent the irregular stimulated volume observed in microseismic data

The differential stress, NDHS and MPSD after being used to assist with hydraulic fracturing design and reservoir simulation software to capture the irregular and variable stimulated volume could provide estimates of the economic impact of each completion design strategy. In some instances, the reduction or increase of completions stages optimized according to their placement only in low differential stress zones could be translated in costs and expenses that could be compared to the revenues generated from the predicted hydrocarbon production derived from reservoir simulation software that also uses the low differential stress zone to simulate the most likely extent of the stimulated reservoir volume that could contribute to the production. Different completion strategies and selection of pad locations, well landing zones, well lengths and azimuths, and choice of number and position of the completion stages based on the differential stress or NDHS and MPSD maps could be evaluated using an economic criteria such the net present value to allow for the optimal and cost effective design strategy.

The previous discussion provides a number of examples of how the results are applied in the context of the present disclosure, however no limitation is intended thereby. Rather, it is understood that the methods of the present disclosure can apply the derived results to a wide array of uses for wells drilled and completed, wells drilled but not completed, and undrilled wells. Accordingly, one of ordinary skill in the art will recognize that extension of the methods of the present disclosure to other uses of the differential stress, NDHS and MPSD, not explicitly described within the present disclosure is within the scope of the present invention.

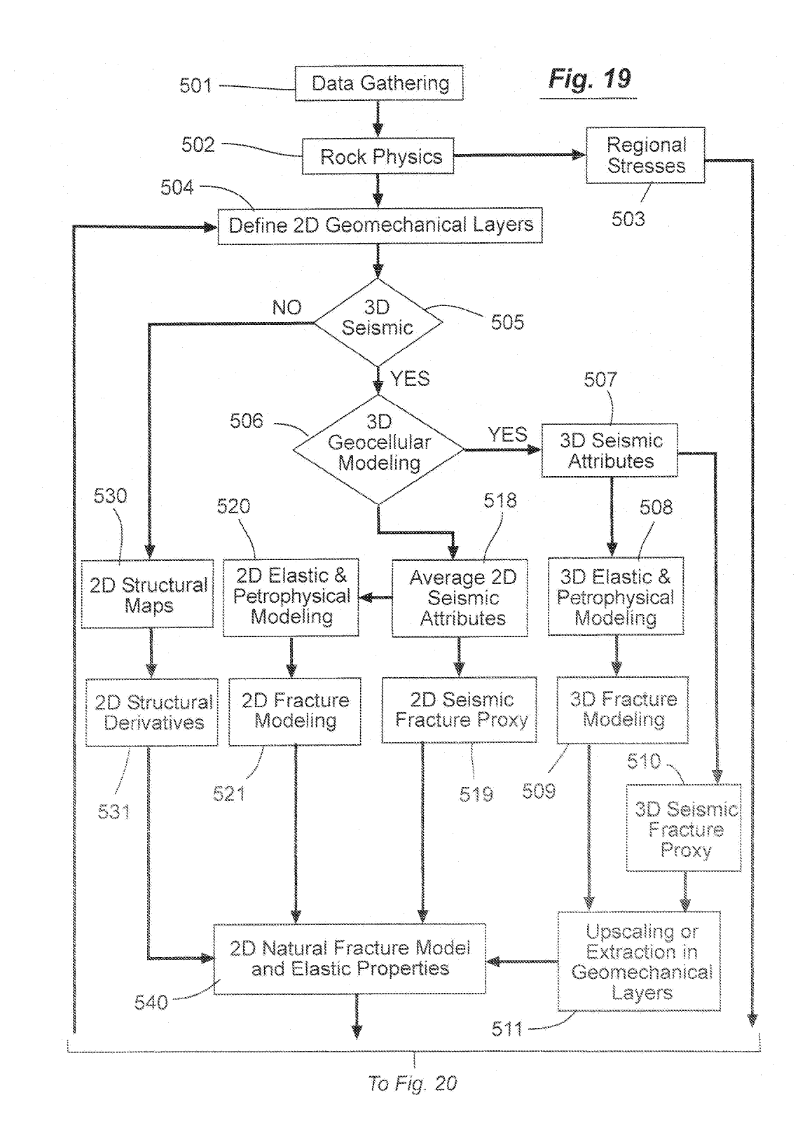

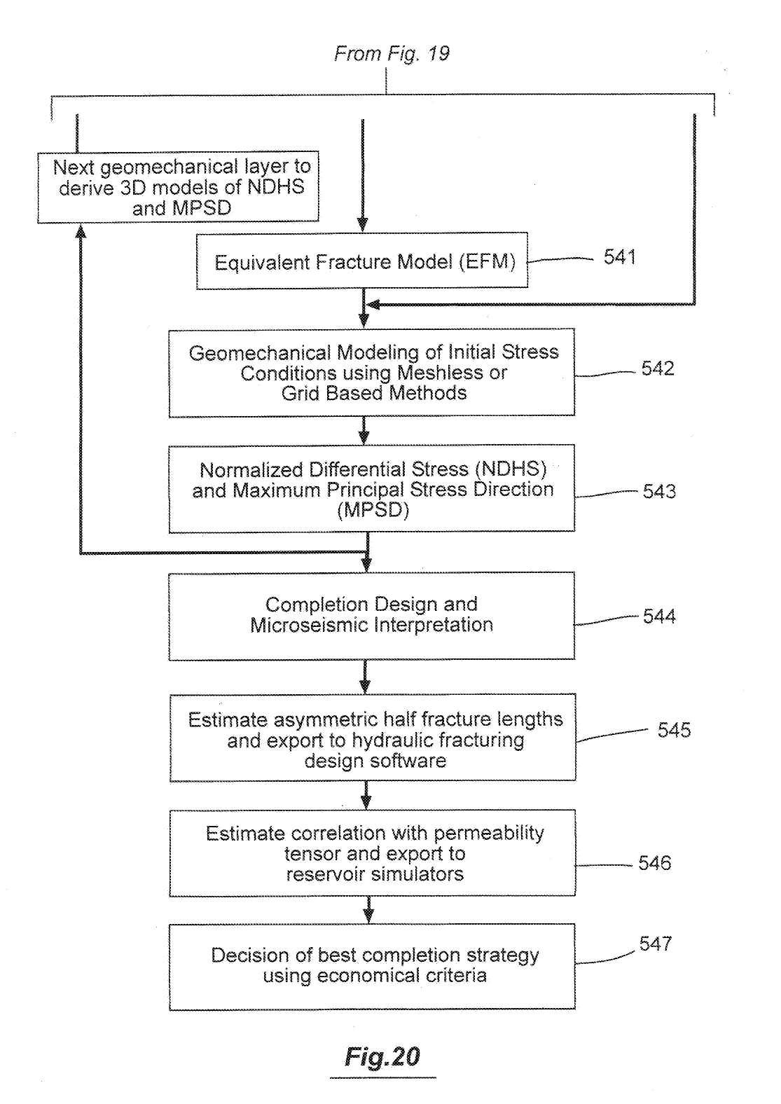

FIGS. 19 and 20 are a flow chart of an example of a process for optimizing the design of hydraulic fractures in naturally subterranean fractured reservoirs. Some or all of the operations in this process can be implemented by one or more computing devices. In some implementations, the process may include additional, fewer or different operations performed in the same or different order. Moreover, one or more of the individual operations or subsets of the operations in the process can be performed in isolation or in different contexts to perform one or more of the disclosed techniques. Output data generated by the process, including output generated by intermediate operations, can include stored, displayed, printed, transmitted, communicated or processed information.

At step 501, data are gathered from different sources as shown in step 151 of FIG. 5. The process starts by applying established rock physics 502 to compute elastic properties using the logs available at the gathered wells. Some of the gathered data and rock physics results will be used to estimate regional stress and magnitude 503. The rock physics results 502 will also serve to define a 2D geomechanical layer 504 where all the subsequent calculations will be made to create the 2D maps of differential stress, NDHS and MPSD. If the data gathering step 501 does not include 3D seismic 505, the process will use 2D structural maps 530 to compute structural derivatives (i.e., structural curvatures 531 which will be used as a proxy for the natural fracture 540). If the data gathering step 501 includes 3D seismic 505 but does not require 3D geocellular modeling 506, the process could be executed using mainly 2D maps without the need for 3D geocellular modeling.

At step 518, the 3D seismic could be used to compute average 2D maps representing average seismic attributes or extractions of 2D seismic maps from existing or computed 3D seismic attributes 518. These 2D seismic attribute extractions or averages could include structural attributes or other types of seismic attributes that could contain information about the natural fractures and could be used directly as a 2D seismic natural fracture proxy 519 which will be considered the 2D natural fracture model. The 2D average or extracted seismic attributes 518 could be used as constraints to build petrophysical and elastic models 520 using multiple reservoir modeling techniques that include deterministic, geostatistics, and artificial intelligence methods such as neural networks. The derived 2D elastic and petrophysical properties 520 could be used to derive 2D fracture models 521 using multiple fracturing modeling methods including neural networks that could find the relationship between any natural fracture measure at the wells and the available and derived 2D seismic attributes, petrophysical, and elastic properties.

At step 507, the 3D seismic could be used to compute a multitude of seismic attributes 507 that will serve either as direct 3D seismic fracture proxy 510 or used as guide and constraints to building 3D elastic and petrophysical models 508 using multiple reservoir modeling techniques that include deterministic, geostatistics, and artificial intelligence methods such as neural networks. The derived 3D elastic and petrophysical properties 508 could be used to derive 3D fracture models 509 using multiple fracturing modeling methods including neural networks that could find the relationship between any natural fracture measure at the wells and the available and derived 3D seismic attributes, petrophysical, and elastic properties. The available 3D seismic fracture proxy 510 or derived 3D fracture model constrained by multiple 3D seismic attributes and petrophyical models 508 is either upscaled in the considered geomechanical layer or extracted along a representative interval of the subterranean formation 511 to provide the 2D natural fracture model 540. The 3D elastic properties 508 are also upscaled in the same geomechanical layer or extracted along the same representative interval of the subterranean formation.

At step 540, the 2D natural fracture model available in the geomechanical layer is converted into an equivalent fracture model 541 where each fracture is represented by a length and an orientation both used as input into a meshless particle-based geomechanical simulator 542 able to represent the natural fractures as explicit segments. After application of the regional stress 117 to the equivalent fracture model 541 and reaching a quasi-equilibrium state, the resulting stress field could be used to compute the normalized horizontal differential stress (NDHS) and the local maximum principal stress direction (MPSD) 543. These two maps could be validated with microseismicity and hydraulic fracture stage performance indicators if they are available. If no validation is possible, then the NDHS and MPSD maps could be used in completion design 544 by selecting the landing zones, well length and optimal positions of the hydraulic fracturing stages. Additionally, the resulting maps could provide an estimate of the maximum asymmetric half-length and orientation to most of the hydraulic fracturing design software. The NDHS and MPSD could also provide an estimate of the extent of the areas most likely to be stimulated, being the area with the lowest differential stress, to reservoir simulators 546. All these different strategies could be evaluated economically (step 547). The same process could be repeated through multiple geomechanical layers to form a 3D volume of NDHS and MPSD.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for optimizing hydraulic fracturing by simulating the geomechanical interaction between regional stress and natural fractures in a reservoir, said method comprising:
creating an equivalent fracture model from data on the natural fracture density, regional stress and elastic properties of the reservoir, in which points in the reservoir have a fracture length and fracture orientation;
simulating the geomechanical interaction between hydraulic fractures and natural fractures in the reservoir by a meshless particle-based method using the equivalent fracture model as an input to estimate differential stress at points in the reservoir; and
selecting regions in the reservoir for hydraulic fracturing having low differential stress based on the simulation.

2. The method of claim 1 wherein the simulation estimates the horizontal differential stress and maximum principal stress direction at points in the reservoir.

3. The method of claim 2 further comprising the step of validating the maximum principal stress direction data against microseismic data for the reservoir.

4. The method of claim 1 further comprising selecting regions in the reservoir for wellbore placement having low differential stress based on the simulation.

5. The method of claim 1 further comprising the step of validating the differential stress data against production data from wells in the reservoir.

6. A method for optimizing hydraulic fracturing by simulating the geomechanical interaction between regional stress and natural fractures in a reservoir, said method comprising:
creating an equivalent fracture model of the natural fractures and elastic properties of the reservoir to generate a vectorial map in which points in the reservoir have a fracture length and fracture orientation;
estimating the horizontal differential stress and maximum principal stress direction at points in the reservoir by meshless particle-based geomechanical simulation using the equivalent fracture model as an input; and
selecting regions in the reservoir for hydraulic fracturing having low horizontal differential stress based on the simulation.

7. The method of claim 6 further comprising the step of validating the maximum principal stress direction data against microseismic data for the reservoir.

8. The method of claim 6 further comprising the step of validating the differential stress data against production data from wells in the reservoir.

9. The method of claim 6 further comprising selecting regions in the reservoir for wellbore placement having low differential stress based on the simulation.

10. A method for optimizing hydraulic fracturing by simulating the geomechanical interaction between regional stress and natural fractures in a reservoir, said method comprising:
creating an equivalent fracture model of the natural fractures and elastic properties of the reservoir to generate a vectorial map in which points in the reservoir have a fracture length and fracture orientation;
estimating the horizontal differential stress and maximum principal stress direction at points in the reservoir by meshless particle-based geomechanical simulation using the equivalent fracture model as an input; and
selecting regions in the reservoir for hydraulic refracturing having high horizontal differential stress based on the simulation.

11. The method of claim 10 further comprising the step of validating the maximum principal stress direction data against microseismic data for the reservoir.

12. The method of claim 10 further comprising the step of validating the differential stress data against production data from wells in the reservoir.

13. The method of claim 10 further comprising selecting regions in the reservoir for refracturing having high differential stress based on the simulation.
